(19) United States
(12) Patent Application Publication
(10) Pub. No.: US 2011/0250948 A1
(43) Pub. Date: Oct. 13, 2011

(54) VIDEO COMPRESSION IN GAMING MACHINES

(75) Inventors: Mark B. Gagner, West Chicago, IL (US); Victor T. Shi, Morton Grove, IL (US)

(73) Assignee: WMS Gaming, Inc., Waukegan, IL (US)

(21) Appl. No.: 13/082,068

(22) Filed: Apr. 7, 2011

Related U.S. Application Data
(60) Provisional application No. 61/321,956, filed on Apr. 8, 2010.

(51) Int. Cl. A63F 9/24; A63F 13/00

(52) U.S. Cl. 463/20; 463/30; 463/43

(57) ABSTRACT

Based on the characteristics of a reel-spinning video, a video encoder/decoder can rely on image date from a preceding video frame to reconstruct a current area of a current frame of the reel-spinning video. The video encoder can record some indication of the current area (e.g., number of dropped blocks or boundary values of the area). The video encoder can rely on motion information (e.g., a motion vector) of a preceding area within the current frame, or encode motion information with the indication of the current area. The video encoder then transmits the indication of the current area, perhaps with a subsequent area, without image data of the current area. The video decoder can then reconstruct the current area with image data from a matching area in the preceding frame based on the motion information.

### RELATED APPLICATIONS

This application claims the priority benefit of U.S. Provisional Application Ser. No. 61/321,956 filed Apr. 8, 2010.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011, WMS Gaming, Inc.

### FIELD

Embodiments of the inventive subject matter relate generally to wagering game systems, and more particularly to video compression in wagering game machines.

### BACKGROUND

Video compression techniques are implemented to reduce bandwidth required to transmit video (e.g., from a server to a wagering game machine) via a communication channel. The video compression techniques use a combination of spatial image compression and temporal motion compensation. Spatial image compression aims to reduce redundancy of video frame content. Temporal motion compensation represents a video frame using information from previous video frames. Spatial image compression is commonly achieved by applying transform coding (e.g., using direct cosine transform, wavelet transform, etc.) followed by quantization and entropy coding. The video compression techniques are applied on groups of neighboring pixels (blocks). The video compression techniques determine and transmit, to the decoding unit, differences between the blocks in the video frame and blocks in the preceding video frame.

### BRIEF DESCRIPTION OF THE FIGURES

Embodiments of the invention are illustrated in the Figures of the accompanying drawings in which:

FIG. 1 depicts a conceptual diagram illustrating example operations for compressing a reel-spinning video frame.

FIG. 2 depicts the conceptual diagram illustrating example operations for compressing the reel-spinning video frame.

FIG. 3 is a conceptual diagram illustrating a relationship between a spin speed of reels and compression ratio.

FIG. 4A is a conceptual diagram illustrating relationship between position of a reel-spin area and compression ratio.

FIG. 4B is a conceptual diagram illustrating relationship between width of an order strip and compression ratio.

FIG. 5 is a block diagram illustrating example operations for reconstructing a frame for presentation on a display unit.

FIG. 6 depicts a flow diagram illustrating example operations for reel-spinning video compression in wagering game machines.

FIG. 7 depicts the flow diagram illustrating example operations for video compression in wagering game machines.

FIG. 8 depicts a flow diagram illustrating example operations for video frame decoding in wagering game machines.

FIG. 9 depicts the flow diagram illustrating example operations for video frame decoding in wagering game machines.

FIG. 10 depicts a flow diagram illustrating example operations for separately encoding a reel-spin area and a residual area of a reel-spinning video frame.

FIG. 11 depicts the flow diagram illustrating example operations for separately encoding the reel-spin area and the residual area of the reel-spinning video frame.

FIG. 12 is a flow diagram illustrating example operations for separately decoding a reel-spin area and a residual area of a reel-spinning video frame.

FIG. 13 is a block diagram illustrating a wagering game network, according to example embodiments of the invention.

FIG. 14 is a block diagram illustrating wagering game machine architecture, according to example embodiments of the invention.

### DESCRIPTION OF THE EMBODIMENTS

The description that follows includes exemplary systems, methods, techniques, instruction sequences, and computer program products that embody techniques of the present inventive subject matter. However, it is understood that the described embodiments may be practiced without these specific details. For instance, although examples refer to selecting a block size for compressing video frames to be transmitted, in other implementations, the block size may vary from frame to frame depending on the content of the frame. In other instances, well-known instruction instances, protocols, structures, and techniques have not been shown in detail in order not to obfuscate the description.

### Introduction

A video slots wagering game machine presents a reel-spinning video comprising multiple (typically 5) reels in a reel-spin area of a video frame and graphics, text, animation, and other effects around the reel-spin area. In a reel-spinning video where the reel-spin area is 780 pixels by 410 pixels, a bandwidth of 184 Mbps is consumed to transmit the reel-spin area at a rate of 24 frames per second with no compression. For transmission of at least 2 streams (a receiving stream and a transmitting stream for the wagering game machine) on a communication channel that achieves a throughput of 10 Mbps, a minimum compression ratio of 40:1 ensures transmission of the reel-spin area in the reel-spinning video frame without frame drops. Although existing video compression schemes (e.g., H.264) can provide compression ratios of over 40:1, the existing video compression schemes are geared towards general-purpose videos, while reel-spinning videos are not necessarily categorized correctly as general-purpose videos. In other words, the existing video compression techniques do not account for characteristics of the reel-spinning videos. To transmit the reel-spinning videos within bandwidth constraints, the existing video compression schemes lower image quality and/or lower frame transmission rate of the reel-spinning video. This can result in the reel-spinning video appearing uneven and irregular. Moreover, dynamic switching in image quality (e.g., transmitting low quality frames during reel-spinning events and transmitting high quality frames after the reel-spinning events end) may cause flicks in the reel-spinning video and may result in a noticeable disturbance in the displayed reel-spinning video.

A reel-spinning video compression technique can achieve a desired high compression ratio within bandwidth constraints (e.g., bandwidth of a network or a bus) by taking into consideration characteristics of the reel-spinning video. For example, as opposed to general-purpose videos, the reel-spinning video has a single direction of motion (e.g., a vertical downward/upward motion), moves without zoom, moves without rotation, moves without tilt, etc., of the reels in the reel-spinning video. The reel-spinning video compression technique also takes advantage of the reels having a common start spin speed and a constant size of the reel-spin area. The reel-spinning video compression process can eliminate the use of bi-directionally predicted frames (i.e., B-frames) commonly used in existing video compression techniques because objects (e.g., a reel) in the reel-spinning video do not occlude other objects. In addition, the level of lighting does not change over time in a reel-spinning video. The reel-spinning video compression technique can determine relationships with preceding frames to effectively compress a reel-spinning video frame. Based on the characteristics of the reel-spinning video, the reel-spinning video compression technique may not encode all blocks that constitute the reel-spinning video frame. The reel-spinning video compression technique can compare each block of a current reel-spinning video frame with blocks in a preceding reel-spinning video frame and accordingly determine whether to encode the block of the current reel-spinning video frame. One or more blocks that constitute the current reel-spinning video frame can be dropped if it is determined that the dropped blocks can be reconstructed based on a motion vector of a preceding block of the current reel-spinning video frame and based on the blocks in the preceding reel-spinning video frame. The reel-spinning video compression process can select a block size to take advantage of the characteristics of the reel-spinning video so that a maximum number of blocks can be dropped in each reel-spinning video frame. This can reduce the amount of data for representing and reconstructing the reel-spinning video frame, thus increasing the compression ratio. The reel-spinning video compression process can transmit differences between the block and a closest match for the block if the block cannot be dropped.

Moreover, the reel-spinning video compression technique can also be configured to extract the reel-spin area from the reel-spinning video frame and apply different compression techniques to the reel-spin area and to a residual area of the reel-spinning video frame to be transmitted as multiple video streams. At the wagering game machine, the multiple video streams can be composited to re-create the reel-spinning video frame. This can allow the reel-spinning video compression technique to apply different compression techniques suited to different areas of the reel-spinning video frame, thus further increasing the compression ratio.

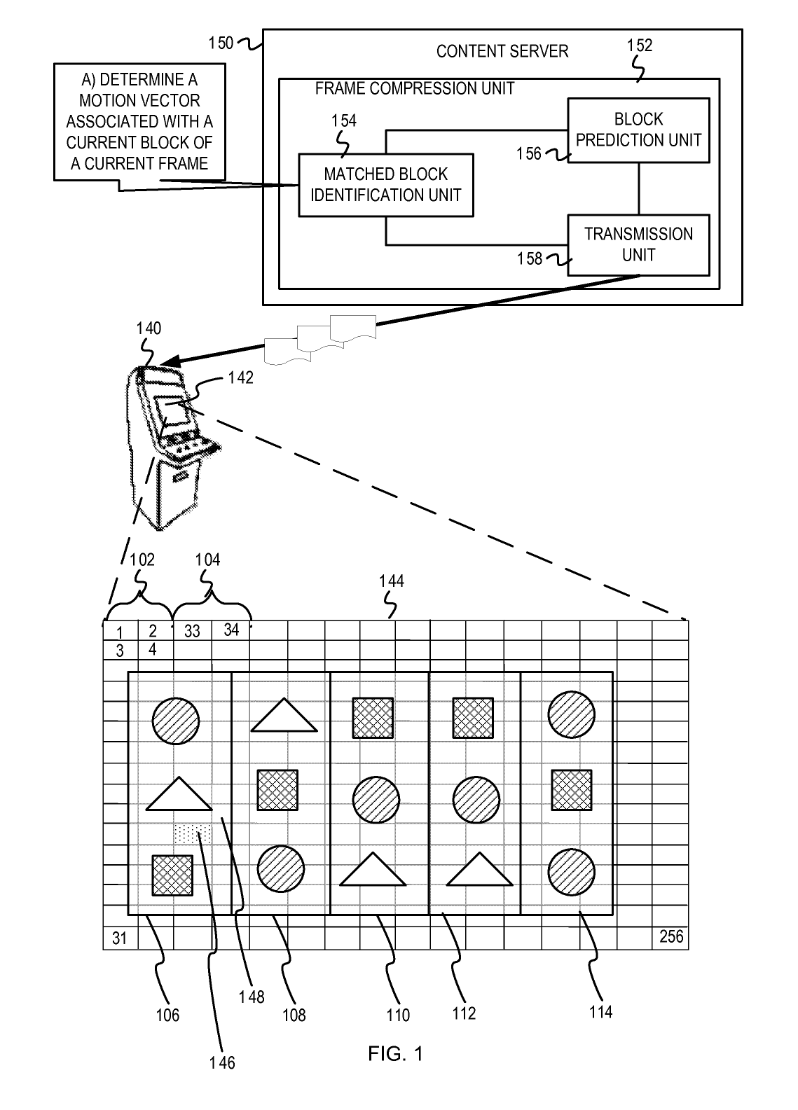

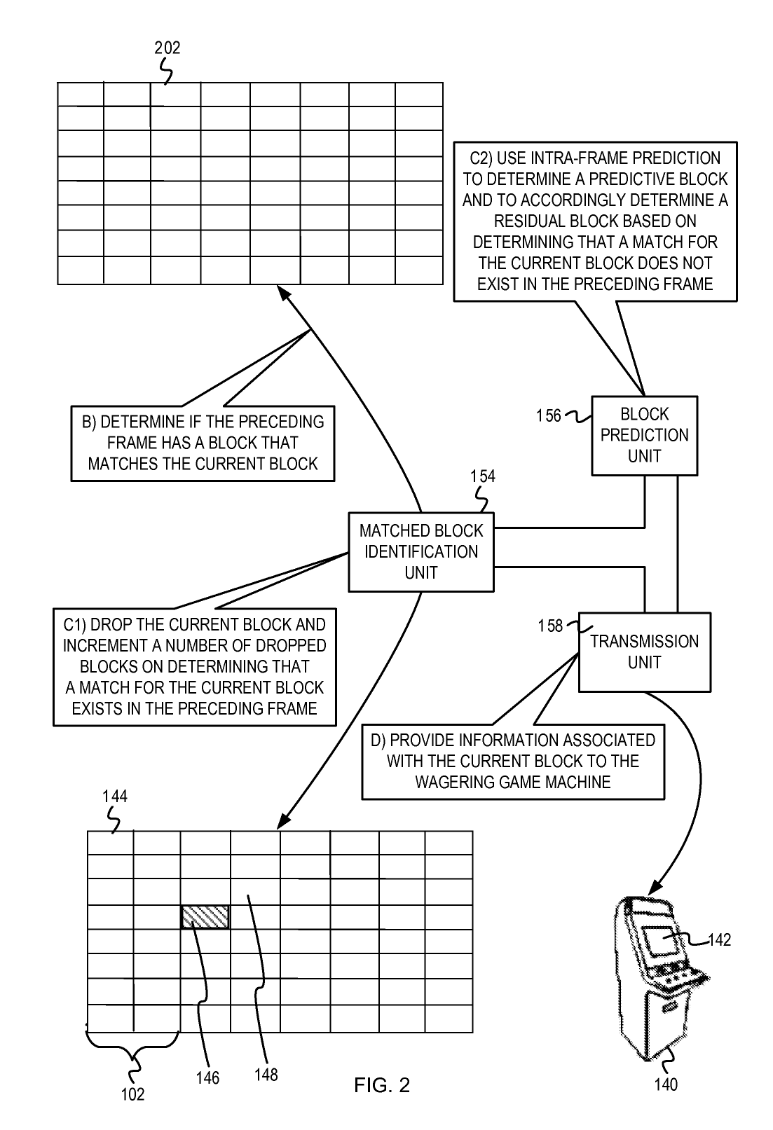

FIG. 1 and FIG. 2 depict a conceptual diagram illustrating example operations for compressing a reel-spinning video frame. FIG. 1 depicts a wagering game machine 140 and a content server 150. The content server 150 comprises a frame compression unit 152. The frame compression unit 152 comprises a matched block identification unit 154, a block prediction unit 156, and a transmission unit 158. The matched block identification unit 154 is coupled with the block prediction unit 156 and the transmission unit 158. Additionally, the block prediction unit 156 is also coupled with the transmission unit 158. The content server 150 determines and provides content (e.g., video frames based on determining an outcome of the video slots wagering game) to be presented by the video slots wagering game machine 140. The wagering game machine 140 comprises a display unit 142, which presents the video slots wagering game. Frame 144 represents one frame of the video slots wagering game that is presented on the display unit 142.

As depicted in FIG. 1, the frame 144 comprises a reel-spin area including five reels—reel 106, reel 108, reel 110, reel 112, and reel 114. Each of the reels 106, 108, 110, 112, and 114 depict a set of symbols. When a user presses a button or pulls a lever on the wagering game machine 140, a reel-spinning video with the symbols in each of the reels 106, 108, 110, 112, and 114 moving (spinning) in a downward direction is presented on the display unit 142. Typically, responsive to user input, the content server 150 generates the reel-spinning video to depict vertical movement of the symbols on the reels 106, 108, 110, 112, and 114 and to depict the outcome of the video slots wagering game. The frame compression unit 152 compresses each frame of the reel-spinning video and transmits the compressed frames to the wagering game machine 140 as will be described below. A decoding unit (not shown in FIG. 1) in the wagering game machine 140, receives the compressed frames, and decompresses and decodes the frames.

Prior to compressing frames of the reel-spinning video, the frame compression unit 152 divides the frame 144 to be compressed (“current frame”) into multiple blocks. In FIG. 1, the frame compression unit 152 divides the current frame 144 into a 16×16 grid (i.e., 256 blocks). The number of blocks that constitute the current frame 144 can be determined based on knowledge of a requisite compression ratio, a number of pixels that should constitute each block, content of the current frame 144, etc. Additionally, the frame compression unit 150 also groups blocks into order strips. An order strip is group of contiguous blocks (typically a column of blocks or a row of blocks) that dictates an order according to which the blocks are processed for compression. The current frame 144 is divided into order strips such that each order strip comprises two columns of blocks (“block columns”). Order strip 102 comprises blocks 1 through 32; order strip 104 comprises blocks 33 through 64 and so on. The blocks that constitute the frame 144 are processed in raster order from left to right and from top to bottom. Also, the order strips are processed from left to right. In other words, blocks in the first order strip 102 are processed first, followed by blocks in the second order strip 104, and so on. It is noted that the blocks can be processed in any suitable order (e.g., zigzag order, vertical order, horizontal order, etc.) that takes advantage of the content of the frame and the presence of multiple reels 106, 108, 110, 112, and 114. The number of blocks that constitute the order strip can be determined based on a requisite compression ratio, a position of the reel-spin area on the current frame 144, a block size, etc.

At stage A, the matched block identification unit 154 determines a motion vector associated with a current block 146 in the current frame 144. The motion vector indicates a displacement of the current block 146 with reference to blocks in a preceding frame. In other words, the motion vector can be used in motion estimation techniques to represent content of the current block 146 by determining variations in motion between a block of a preceding frame and the current block 146. To determine the motion vector associated with the current block 146, the matched block identification unit 154 first determines a motion vector of a preceding block 148 in the current frame 144. It is noted that because the blocks in the order strip 104 are processed in raster order (for the example of FIG. 1), the block 148 precedes the block 146. The matched block identification unit 154 determines if the motion vector of the preceding block 148 is a valid motion vector. A motion vector may be considered as valid if the motion vector references a block within the current frame, lies within a valid range of values, etc. If the motion vector of the preceding block 148 is a valid motion vector, the matched block identification unit 154 assigns the motion vector of the preceding block 148 to the current block 146. Alternately, if the motion vector of the preceding block 148 is not a valid motion vector, the matched block identification unit 154 initializes the motion vector of the current block 146 to (0, 0).

FIG. 2 depicts a conceptual diagram that continues the illustration from FIG. 1. At stage B in FIG. 2, the matched block identification unit 154 determines if the preceding frame 202 has a block that matches the current block 146 in the current frame 144 being processed. It is noted that, for simplicity, the current frame 144 and the preceding frame 202 do not depict all the blocks that constitute the frames, the reels, and other components of the frame (as was depicted in FIG. 1). The matched block identification unit 154 uses the motion vector of the current block 146 (determined at stage A) to identify a block of the preceding frame 202. The matched block identification unit 154 tries to identify a block that matches the current block 146 in terms content based on the motion vector of the current block 146. If the matched block identification unit 154 is unable to find a match for the current block 146, then the matched block identification unit 154 may compare the current block 146 with a search area in the preceding frame 202 or employ a different compression technique.

At stage C1, the matched block identification unit 154 determines that a match for the current block 146 exists in the preceding frame 202. The matched block identification unit 154 drops the current block 146 and increments a dropped blocks counter. Dropping the current block 146 indicates that the current block 146 can be completely reconstructed based on the motion vector of the preceding block 148 in the current frame 144.

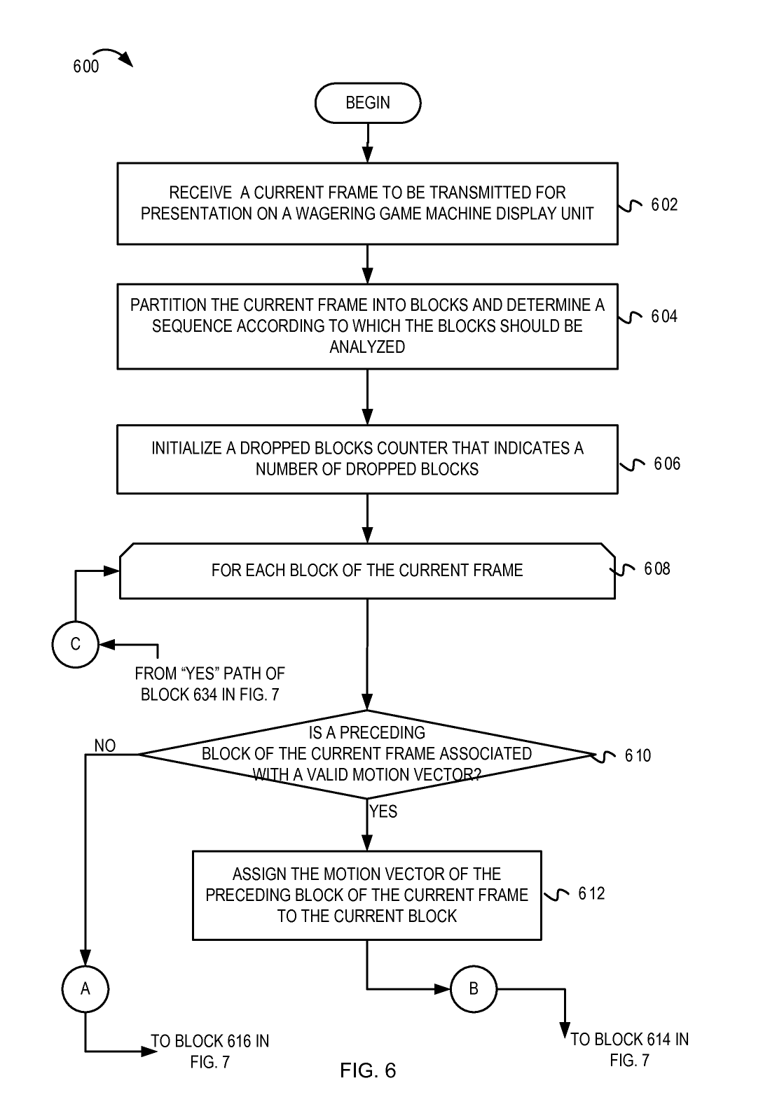

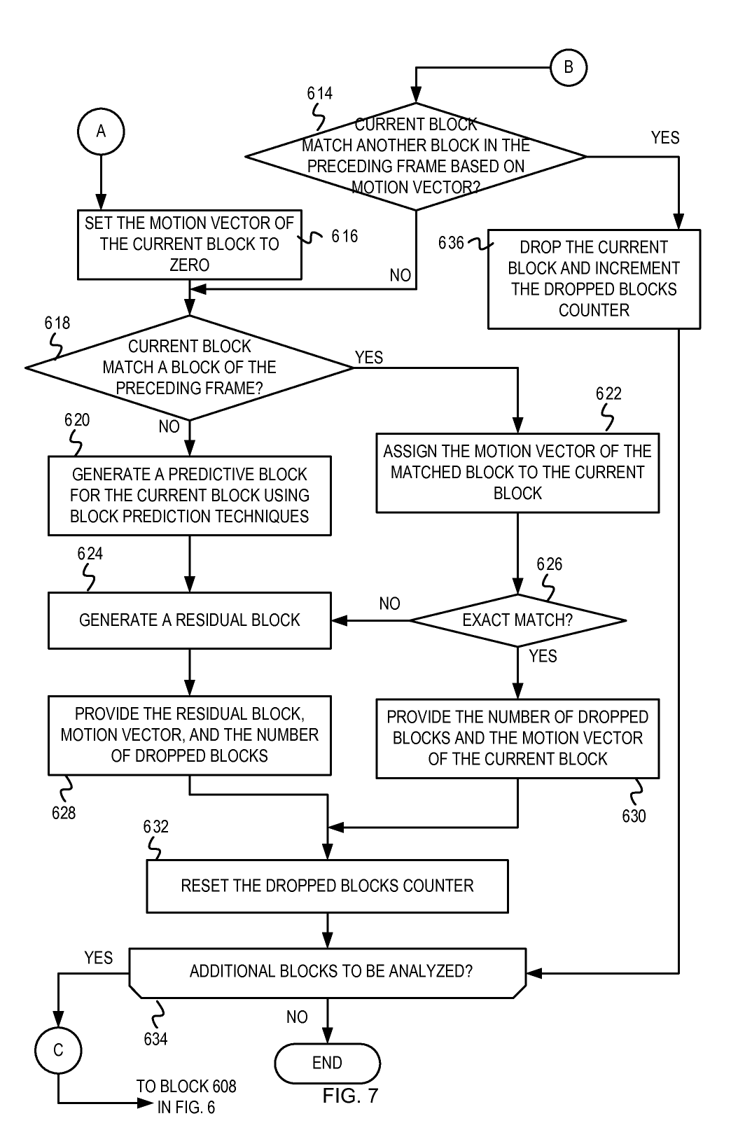

In the alternative to stage C1, at stage C2, the matched block identification unit 154 determines that a match for the current block 146 does not exist in the preceding frame 202. The block prediction unit 156 uses intra-frame prediction techniques to determine a predictive block of the current block 146. The predictive block can be determined based on a subset of previously encoded blocks in the current frame 144. It is noted, however, that the block prediction unit 156 may use any suitable block prediction techniques (e.g., intra-frame prediction) to generate the predictive block. The block prediction unit 156 can also calculate a residual block that indicates differences between the current block 146 and the predictive block. As will be described with reference to FIGS. 6 and 7, if a partial match for the current block 146 is found in the preceding frame 202, the block prediction unit 156 may not generate the predictive block. Instead, the block prediction unit 156 can calculate a residual block to indicate the differences between the current block 146 and the block of the preceding frame 202 that partially matches the current block 146.

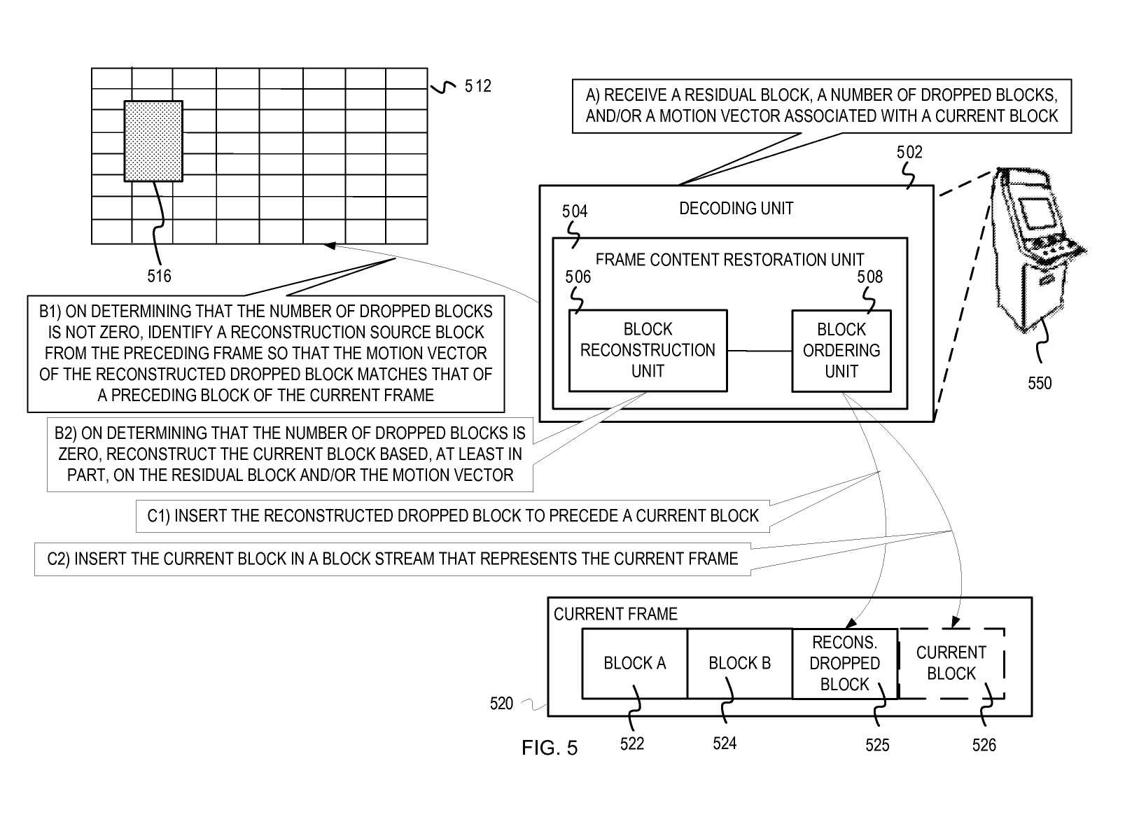

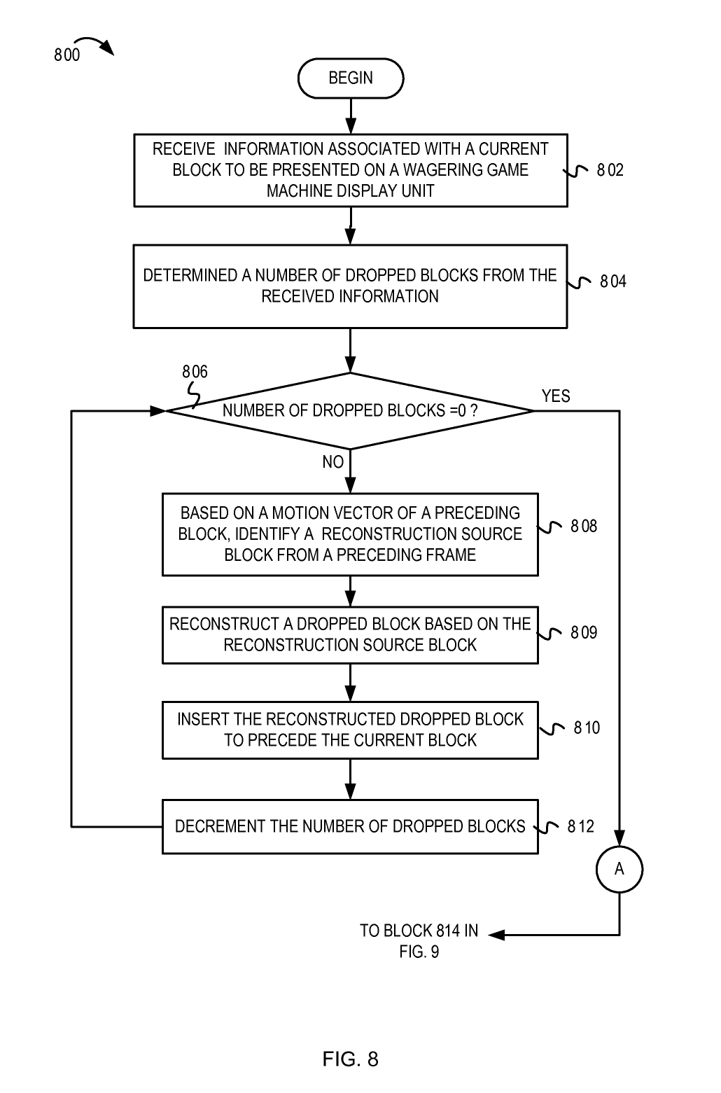

At stage D, the transmission unit 158 provides information associated with the current block 146 to the video slots wagering game machine 140. The transmission unit 158 can quantize, encode, encrypt, and convert the information associated with the current block 146 into a format suitable for transmission. The information associated with the current block 146 can comprise the motion vector associated with the current block 146, a number of dropped blocks, the residual block associated with the current block 146, a position of the current block 146 within the current frame 144, etc. As will be described with more detail in FIGS. 5, 8, and, 9, on receiving the information associated with the current block 146, a decoding unit in the wagering game machine 140 can reconstruct the blocks that constitute the current frame 144 and can present the current frame 144 on the display unit 142.

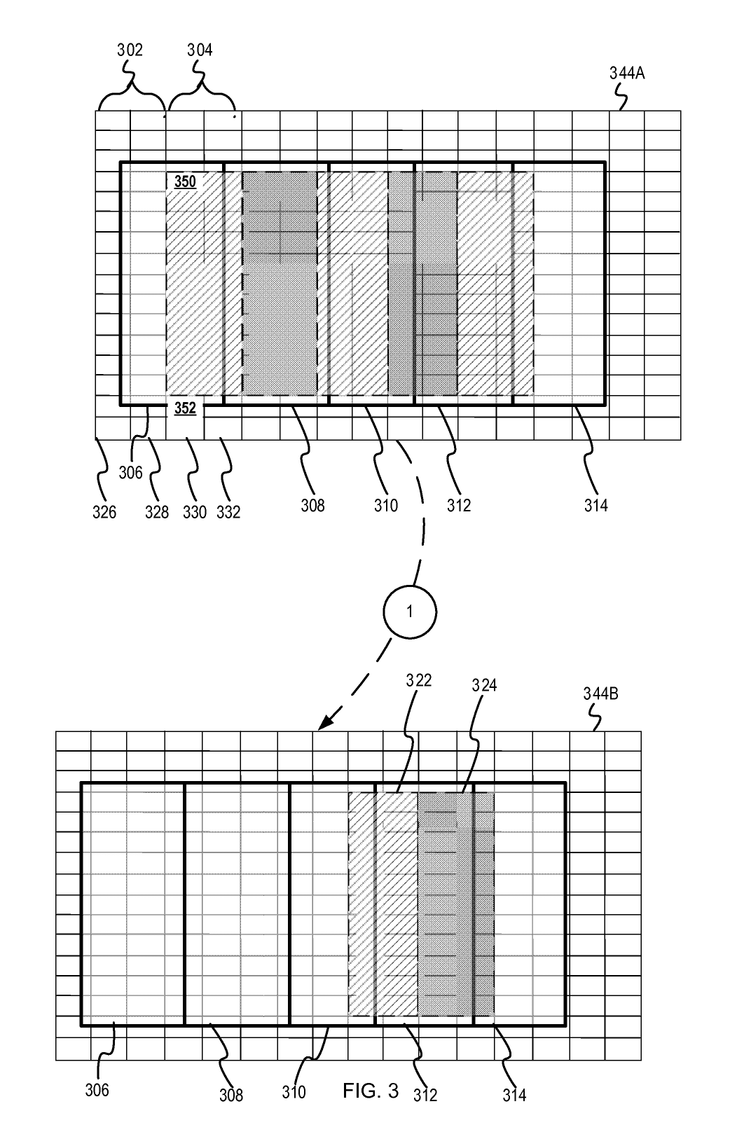

FIG. 3 is a conceptual diagram illustrating a relationship between a spin speed of reels displayed by a reel-spinning video and compression ratio.

FIG. 3 depicts a frame 344A that is divided into 16×16 blocks. The blocks that constitute the frame 344A are grouped into eight order strips, such that each order strip comprises two block columns. A left-most order strip 302 comprises block columns 326 and 328. A next order strip 304 comprises block columns 330 and 332, and so on. A reel-spin area on the frame 344A comprises five reels—reel 306, reel 308, reel 310, reel 312, and reel 314. The reel-spin area is positioned on the frame 344A so that the reel 306 encompasses a portion of the block column 326, the block columns 328 and 330, and a first portion of the block column 332. Thus, the reel 306 encompasses about 3 block columns. The reels 308, 310, 312, and 314 are placed contiguous to each other and also encompass about three block columns. Responsive to the user input, all the reels 306, 308, 310, 312, and 314 start spinning at the same spin speed. In the block columns 330 and 332, blocks 350 and 352 lie within the order strip 304 and are respectively at the upper and lower boundaries of the reel 306. The blocks that lie between the block 350 and the block 352 (the end blocks being non-inclusive) have the same motion vector as the block 350 because the blocks lie within the reel 306. Thus 21 blocks that lie between the blocks 350 and 352 can be dropped. The dropped blocks can be reconstructed based on knowledge of the motion vector associated with the block 350. The block 352 lies partially outside the reel-spin area and therefore has a motion vector that is different from that of the block 350. Therefore, the block 352 cannot be dropped. The reel-spin area encompasses 5 complete order strips. Therefore, 21 blocks from each of the 5 order strips that lie within the reel-spin area can be dropped. In other words, a total of 21*5=105 blocks can be dropped from the frame 344A and need not be encoded and transmitted to the wagering game machine. Thus, when the spin speed of all the reels 306, 308, 310, 312, and 314 is the same, the compression ratio achieved (for the frame 344A when divided into 256 blocks) can be calculated as 256:(256−105)=256:151.

Frame 344B illustrates the effect of a subset of the reels 306, 308, 310, 312, and 314 spinning at a different spin speed. A dashed line denoted by “1” indicates a transition from the frame 344A to the frame 344B after the reels 306 and 308 slow down. Because the spin speed of the reels 306 and 308 is different from the spin speed of the reels 310, 312, and 314, and the spin speed of the reels 310, 312, and 314 are the same, the blocks that constitute order strips that lie within the reels 310, 312, and 314 are compressed in accordance with the video reel compression technique. As depicted in the frame 344B, the reels 310, 312, and 314 together encompass two order strips—order strip 322 in the reels 310 and 312 and order strip 324 in the reels 312 and 314. In a similar fashion as described above, 21 blocks from each of the two order strips 322 and 324 can be dropped. Thus, when the spin speed of three of the five reels is the same, the compression ratio can be calculated as 256:(256−2*21)=256:214.

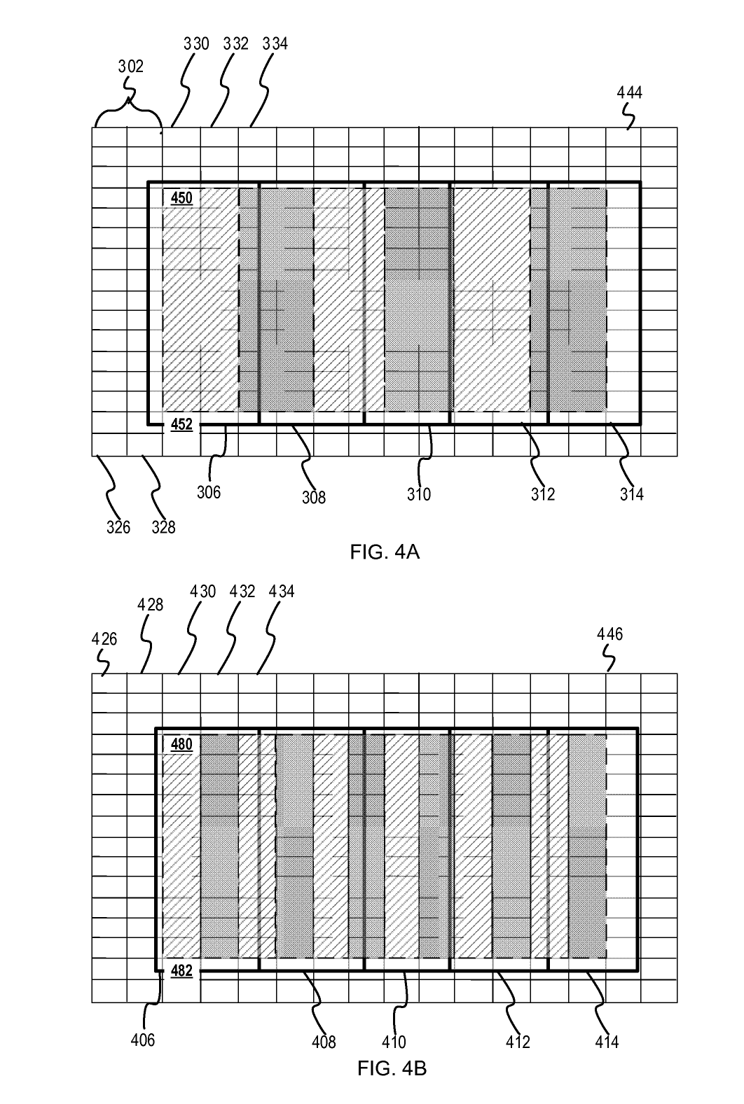

In addition to being dependent on the spin speed, the compression ratio may also be influenced by the position of the reel-spin area on the frame as illustrated in FIG. 4A. FIG. 4A depicts a frame 444, where a reel-spin area comprising the reels 306, 308, 310, 312, and 314 is shifted to the right with reference to the frame 344A of FIG. 3. The reel-spin area of FIG. 4A is shifted so that the reel 306 now encompasses approximately a half of block column 328 of the first order strip 302, the block columns 330 and 332 of the second order strip, and approximately a first half of block column 334 of a third order strip. The reels 308, 310, 312, and 314 are each placed contiguous to each other and have the same width as the reel 306. Therefore, as depicted in FIG. 4A, the reel-spin area now spans six order strips. In the block columns 330 and 332, blocks 450 and 452 lie within the order strip 304 and are respectively at the upper and lower boundaries of the reel 306. The blocks that lie between block 450 and block 452 (the blocks 450 and 452 being non-inclusive) have the same motion vector as the block 450 because the blocks lie within the reel 306. Thus 21 blocks that lie between the blocks 450 and 452 can be dropped. The dropped blocks can be reconstructed based on knowledge of the motion vector associated with the block 450. The block 452 lies partially outside the reel 306 of the reel-spin area and therefore has a motion vector that is different from the motion vector of the block 450. Therefore, the block 452 cannot be dropped. The reel-spin area spans six complete order strips. Therefore, 21 blocks from each of the six order strips that lie within the reel-spin area of the frame 444 can be dropped. In other words, a total of 21*6=126 blocks can be dropped from the frame 444 and need not be encoded and transmitted to the wagering game machine. Thus, when the spin speed of all the reels 306, 308, 310, 312, and 314 is the same, the compression ratio achieved (for the frame 444 when divided into 256 blocks) can be calculated as is 256:(256-126)=256:130. Thus, the position of the reel-spin area within the reel-spinning video affects the compression ratio as can be observed based on comparing the compression ratio (i.e., 256:130) calculated for the position of the reels 306, 308, 310, 312, and 314 depicted in FIG. 4A with the compression ratio (i.e., 256:151) calculated for the position of the reels 306, 308, 310, 312, and 314 depicted in FIG. 3.

Additionally, the compression ratio may also be influenced by the width of the order strip (i.e., a number of block columns that constitute the order strip) as illustrated in FIG. 4B. FIG. 4B depicts a frame 446 comprising five reels 406, 408, 410, 412, and 414. The position of the reels 406, 408, 410, 412, and 414 on the frame 446 is as described with reference to FIG. 4A. In FIG. 4B, the width of one order strip equals the width of a block. Thus, a first block column 426 that constitutes the frame 446 is a first order strip, a second block column 428 is a second order strip, a third block column 430 is a third order strip, and so on. The reel-spin area of the frame 446 spans 12 block columns (i.e., 12 order strips) beginning at the block column 430. In the block column 430, blocks 480 and 482 are respectively at the upper and lower boundaries of the reel 406. The blocks that lie between the block 480 and the block 482 (the blocks 480 and 482 being non-inclusive) have the same motion vector as the motion vector of block 480 because the blocks lie completely within the reel 406. Therefore, 10 blocks that lie between the block 480 and the block 482 can be dropped. The block 482 cannot be dropped because the block 482 lies partially outside the reel 406 and therefore has a motion vector that is different from the motion vector of the block 480. Because the reel-spin area of the frame 446 spans 12 order strips, a total of 12*10=120 blocks can be dropped from the frame 446. Also, the compression ratio can be calculated as 256:(256−120)=256:136. Thus, the compression ratio can be varied by varying the order strip size as is illustrated by comparing the compression ratio associated with the frame 446 of FIG. 4B (where an order strip comprises one block column) to the compression ratio calculated for the frame 444 of FIG. 4A (where an order strip comprise two block columns).

FIG. 5 is a block diagram illustrating example operations for reconstructing a frame for presentation on a display unit. FIG. 5 depicts a video slots wagering game machine 550 comprising a decoding unit 502. The decoding unit 502 comprises a frame content restoration unit 504. The frame content restoration unit 504 comprises a block reconstruction unit 506 and a block ordering unit 508. The block reconstruction unit 506 is coupled with the block ordering unit 508. The decoding unit 502 implements functionality to reconstruct blocks and consequently to re-generate a frame for presentation on a display unit of the video slots wagering game machine 550 as will be described in stages A, B1-C1, and B2-C2.

At stage A, the decoding unit 502 receives information associated with a current block 526 in a current frame 520. The information can comprise a residual block associated with the current block 526, a number of dropped blocks to be inserted to precede the current block 526, and/or a motion vector associated with the current block 526. In some implementations, the decoding unit 502 may receive a signal comprising encoded information associated with the current block 526. The decoding unit 502 can extract the encoded information from the received signal and can decode the encoded information to retrieve the information associated with the current block 526.

At stage B1, the block reconstruction unit 506 determines that the number of dropped blocks is not equal to zero. Based on determining that the number of dropped blocks is not zero, the block reconstruction unit 506 identifies a block of a preceding frame 512 with a motion vector that equals the motion vector of a preceding block of the current frame 520. The current frame 520 depicts three blocks—block 522 and block 524 represent the blocks that have already been reconstructed by the block reconstruction unit 506 and that have been inserted into a block stream that represents the current frame 520. The current block 526 is represented using dashed lines to indicate that the block reconstruction unit 506 is currently processing the current block 526. To reconstruct the dropped block, the block reconstruction unit 506 determines the motion vector of the block 524 that precedes the current block 526 in the current frame 520. The block reconstruction unit 506 then identifies a block of the preceding frame 512 (“reconstruction source block”) based on the motion vector of the block 524. The block reconstruction unit 506 then reconstructs a dropped block (“reconstructed dropped block”) based upon the reconstruction source block identified.

At stage C1, the block ordering unit 508 inserts the reconstructed dropped block to precede the current block 526. As depicted in the current frame 520, the reconstructed dropped block 525 is inserted into the block stream so that the reconstructed dropped block 525 follows the block 524 and precedes the current block 526. The block reconstruction unit 506 and the block ordering unit 508 repeat operations described in stages B1 and C1 until all the consecutively dropped blocks have been reconstructed. After the dropped blocks have been reconstructed, the block reconstruction unit 506 and the block ordering unit 508 perform operations described in stages B2 and C2 to reconstruct the current block 526.

At stage B2, the block reconstruction unit 506 determines that the number of dropped blocks is equal to zero. The number of dropped blocks has dropped to zero because the number has been decremented as each dropped block is reconstructed or inserted into the frame. Embodiments are not limited to decrementing and determining whether a counter has been decremented to zero. Embodiments can set a loop control value to the value of the number of dropped blocks to repeat the reconstruction and insertion operations. Embodiments can also set a flag when the consecutive dropped blocks have been reconstructed. After reconstructions and insertion of the dropped blocks, the block reconstruction unit 506 reconstructs the current block 526 based, at least in part, on the residual block associated with the current block 526 and/or the motion vector associated with the current block 526 (determined at stage A). If the information received at stage A comprises the motion vector associated with the current block 526, the block reconstruction unit 506 searches an area of the preceding frame 512 based on the motion vector and identifies a block (“matched block”). The block reconstruction unit 506 determines if a residual block associated with the current block 526 was received at stage A. If a residual block was received, the block reconstruction unit 506 combines the residual block with the matched block to reconstruct the current block 526. If the residual block was not received, the block reconstruction unit 506 determines that the matched block and the current block 526 comprise the same content and that the matched block can be substituted as the current block 526. If the information received at stage A does not comprise the motion vector associated with the current block 526, the block reconstruction unit 506 generates a predictive block based on knowledge of previously decoded blocks adjacent to the current block 526 in the current frame 520. For example, the block reconstruction unit 506 can use the blocks 522, 524, and 525 (along with other previously decoded blocks if required) to generate the predictive block. The block reconstruction unit 506 combines the predictive block with the residual block to reconstruct the current block 526.

At stage C2, the block ordering unit 508 inserts the current block in the block stream that represents the current frame 520. As each block that constitutes the current frame is reconstructed, the block ordering unit 508 arranges the blocks to generate the current frame 520. The information received at stage A can comprise block identification information that indicates an order according to which the blocks should be arranged to reconstruct the current frame 520. After the current frame is reconstructed, the decoding unit 502 provides the current frame for display by the wagering game machine 550.

### Example Operations

This section describes operations associated with some embodiments of the invention. In the discussion below, the flow diagrams will be described with reference to the block diagrams presented above. However, in some embodiments, the operations can be performed by logic not described in the block diagrams. In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

FIG. 6 and FIG. 7 depict a flow diagram illustrating example operations for reel-spinning video compression in wagering game machines. Flow 600 begins at block 602 in FIG. 6.

At block 602, a current frame to be transmitted for presentation on a wagering game machine display unit is received. The flow continues at block 604.

At block 604, the current frame is partitioned into blocks and a sequence according to which the blocks should be analyzed is determined. The current frame can be partitioned into any suitable number of blocks. The number of blocks that constitute the current frame may depend on various factors such as a desired compression ratio, a requisite number of pixels in each block, content of the current frame, etc. In some implementations, all the frames to be transmitted may be partitioned into a uniform number of blocks. In other implementations, the number of blocks that constitute the current frame may differ from the number of blocks that constitute a preceding or a subsequent frame. After the current frame is partitioned into blocks, the blocks can be grouped into order strips to determine the sequence according to which the blocks should be analyzed. An order strip typically constitutes a set of one or more adjacent blocks columns. With reference to FIG. 3, each order strip comprises two block columns. The order strip 302 comprises the block columns 326 and 328. However, embodiments are not so limited. Order strips can comprise a single block column (as depicted in FIG. 4B), an entire frame, or any other suitable number of block columns depending on the requisite compression ratio. In some implementations, the blocks within an order strip may be processed in raster order i.e., from left to right and from top to bottom. Order strips may also be processed from left to right. In other words, blocks in a first (left-most) order strip may be processed first, blocks in a second order strip may be processed after all the blocks in the first order strip are processed, and so on. In other implementation, the blocks may be processed in any suitable order (e.g., a zigzag order, a vertical order, etc.). The flow continues at block 606.

At block 606, a counter that indicates a number of dropped blocks (“dropped blocks counter”) is initialized. As will be described below, a value in the dropped blocks counter indicates a number of blocks whose motion vector and content can be reconstructed based on a motion vector of a preceding block of the current frame and based on a block or blocks in a preceding frame. The dropped blocks counter keeps track of the number of consecutive blocks that are discarded. The flow continues at block 608.

At block 608, a loop begins to perform a set of operations (described in blocks 610-632 in FIG. 6 and FIG. 7) for each block of the current frame. The flow continues at block 610.

At block 610, it is determined whether a preceding block of the current frame is associated with a valid motion vector. The preceding block may be within the same order strip as the current block or within a preceding order strip of the current frame. In determining whether the motion vector of the preceding block is a valid motion vector, it may be determined whether the motion vector represents a valid range of motion. For example, based on knowledge that motion in the reel-spin area is in a vertical downward direction, a motion vector with a horizontal component may be regarded as invalid. In determining whether the motion vector of the preceding block is a valid motion vector, it may also be determined whether the motion vector lies within a valid range of values. For example, if a vertical component of the motion vector is configured to lie within a range of 0-255, a motion vector with a vertical component of 260 may be regarded as invalid. Also, the motion vector of the preceding block may be an invalid motion vector, if the motion vector references a position outside the current frame. In some implementations, the motion vector of the preceding block may be an invalid motion vector, if the preceding block is part of a different order strip or a different frame. If it is determined that the preceding block is associated with a valid motion vector, the flow continues at block 612. Otherwise, the flow continues at block 616 in FIG. 7.

At block 612, the current block is assigned the motion vector of the preceding block of the current frame. Assigning the motion vector of the preceding block to the current block indicates that both the preceding block and the current block have the same direction of motion. This allows for performing an initial search of the blocks in the preceding frame to determine whether there exist blocks in the preceding frame with the same motion vector and the same content as the current block. For example, blocks within a reel-spin area of a reel-spinning video may have the same motion vector and the same content from one frame to another. The flow continues at block 614 in FIG. 7.

At block 614 in FIG. 7, it is determined whether the current block matches another block in the preceding frame based on the assigned motion vector. If it is determined that the current block matches another block within the preceding frame, the flow continues at block 636. Otherwise, the flow continues at block 618. At block 636, the current block is dropped and the dropped blocks counter is incremented. The current block is dropped if it is determined that a match for the current block was identified, in the preceding frame, using the motion vector of the preceding block of the current frame. Dropping the current block indicates that the current block can be identified from the preceding frame based on knowledge of the motion vector of the preceding block of the current frame. The current block is thus not encoded and during a decoding stage, a decoder will rely on previously decoded blocks and frames to reconstruct the dropped block. After the current block is dropped and the dropped blocks counter is incremented, operations for processing the current block end and the flow continues at block 634, where it is determined whether there exists another block, in the current frame, to be analyzed.

At block 616, the motion vector of the current block is set to zero. The flow 600 moves from block 610 in FIG. 6 to block 616 in FIG. 7 if it is determined that the motion vector of the preceding block is not valid. The flow 600 also moves from block 614 to block 616 if it is determined that the current block does not match another block within the preceding frame. By setting the motion vector of the current block to zero, the content of the current block (and not the displacement, i.e., the motion vector) is compared against the blocks that constitute the preceding frame to identify (if possible) a block that matches the current frame as will be described below. The flow continues at block 618.

At block 618, it is determined whether the current block matches another block in a search area of the preceding frame. The search area is based on the motion vector assigned at block 612 if a matching block was not found at block 614. The search area is based on position of the current block within the current frame if the motion vector was set to zero at block 616. Although the search areas of these two different cases may be the same, the search areas are often different. The search area may comprise a predetermined number of blocks in the preceding frame that are searched to determine whether a match for the current block can be identified. The search area typically comprises only a small fraction of the blocks that constitute the preceding frame and relies on the assumption that a match for the current block is most likely to be found within a corresponding area in the preceding frame. In some implementations, the search area can be configured based on knowledge of the content of the current frame. For example, based on knowledge that the current block lies within the reel-spin area of the current frame, the search area can be configured so that the search area allows more upward search than downward search because reel-spinning moves faster in the downward direction than in the upward direction. Identifying another block within the search area that matches the current block can indicate that the content of the current block need not be separately encoded and transmitted to the wagering game machine, thus reducing the amount of data that is to be transmitted. During a decoding stage, based on knowledge of the motion vector of the preceding block or position of a current block within a current frame. To determine whether the current block matches a block within the search area, a similarity calculation may be performed between blocks that constitute the search area and the current block. A mean absolute error or a mean square error can be determined to perform the similarity calculation. It may be determined that the current block matches another block within the search area if the mean absolute error or the mean squared error is less than a threshold.

The motion vector of the current block is initialized to zero (i.e., zero displacement) at block 616 and the search in the preceding frame is performed again to identify a match for the current block (“matched block”) without taking the motion vector of the current block into consideration. The content of the matched block may not be an exact match for the current block. The matched block may be determined so that the matched block is similar to the current block within at least a threshold. To identify the matched block, a mean square error between the current block and the blocks in the preceding frame may be calculated. The matched block may be identified as the block of the preceding frame that has a mean square error that is less than a threshold. If it is determined that the current block matches another block of the preceding frame, the flow continues at block 622. Otherwise, the flow continues block 620.

At block 622, the motion vector of the matched block is assigned to the current block. In doing so, the motion vector of the current block is configured to point to the matched block. During the decoding stage, the matched block can be identified from the preceding frame based on knowledge of the motion vector associated with the current block and the matched block can be used to reconstruct the current block. The flow continues at block 626.

At block 626, it is determined whether the current block matches the matched block. For example, it may be determined that the current block matches the matched block if the calculated mean square error is less than some threshold or predefined value. If it is determined that the current block matches the matched block, the current block can be reconstructed from the matched block and the flow continues at block 630. Otherwise, the flow continues at block 624, where differences between the matched block and the current block are calculated to allow reconstruction of the current block.

At block 630, the number of dropped blocks and the motion vector of the current block are provided to the wagering game machine. The number of dropped blocks is determined from the dropped blocks counter. The number of dropped blocks and the motion vector of the current block can be quantized, encoded, encrypted, and converted into a format suitable for transmission. In one implementation, the number of dropped blocks can be provided as part of the motion vector. As described above, the motion vector of a block within the reel-spin area typically does not have an X-coordinate (e.g., the x-coordinate is zero) because the block within the reel-spin area only has a vertical displacement. The number of dropped blocks could be encoded in the motion vector as a fake X-coordinate. At the decoding stage, the absolute value of the X-coordinate of the motion vector can be compared against a threshold. If the absolute value of the X-coordinate of the motion vector is less than the threshold, it may be determined that the X-coordinate of the motion vector indicates the number of dropped blocks. The flow continues at block 632, where the dropped blocks counter is reset and it is determined whether there exist additional blocks, in the current frame, to be analyzed.

At block 620, block prediction techniques are used to generate a predictive block for the current block. The flow 600 moves from block 618 to block 620 if it is determined that the current block does not match any block of the preceding frame. Intra-frame prediction techniques, inter-frame prediction techniques, or other suitable prediction techniques can be used to generate the predictive block. Intra-frame prediction techniques predict the content of the current block based on content of one or more blocks in the current frame that are spatially adjacent to the current block. Any suitable number of blocks can be used to generate the predictive block for the current block. For example, intra-frame prediction techniques may use blocks that are along the left and top boundaries of the current block (“boundary blocks”) to generate the predictive block. The flow continues at block 624.

At block 624, a residual block is generated. The flow 600 moves from block 620 to block 624 after the predictive block is generated in response to determining that the current block does not match any block of the preceding frame. As was described with reference to block 620, the predictive block is generated based on a subset of previously encoded blocks. The residual block is generated to indicate differences between the current block and the predictive block. The flow 600 also moves from block 626 to block 624 if it is determined that although the matched block identified in the preceding frame only partially matches the current block. The residual block may be generated by subtracting the matched block from the current block. The residual block indicates differences between the current block and the matched block. The flow continues at block 628.

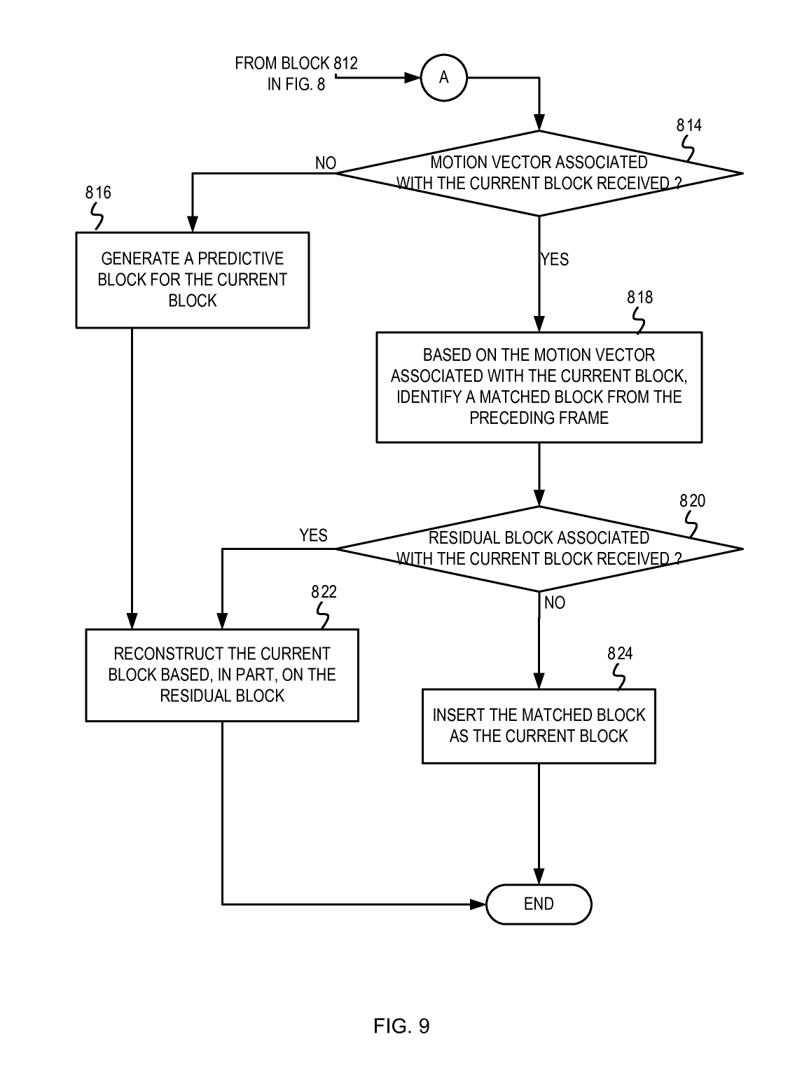

At block 628, the residual block, the motion vector, and the number of dropped blocks are provided to the wagering game machine. The residual block can be encoded using direct cosine transform (DCT), scaled, and quantized. The motion vector, the number of dropped blocks, and the residual block can be further entropy encoded and provided to the wagering game machine. In some implementations, identifiers of the previously encoded blocks that were used to generate the predictive block may also be transmitted. During the decoding stage, the number of dropped blocks can be used to determine a number of blocks that should be reconstructed from previously decoded frames and that should be inserted to precede the current block. Also, the residual block can be combined with the predictive block (predicted from previously decoded blocks) or with a matched block (determined based on knowledge of the motion vector) to reconstruct the current block. This will further be described with reference to FIGS. 8 and 9. The flow continues at block 632, where the dropped blocks counter is reset and it is determined whether there exist additional blocks to be analyzed.

At block 632, the dropped blocks counter is reset. The flow 600 moves from block 630 and from block 628 to block 632 after the information (e.g., motion vector of the current block, number of blocks prior to the current block that were dropped, residual block for reconstructing the current block, etc.) is provided for transmission. The flow continues at block 634.

At block 634, it is determined whether there exist additional blocks in the current frame to be analyzed. The flow 600 moves from block 636 to block 634 after the current block is dropped in response to determining that the current block can be assigned the motion vector of the preceding block and can be reconstructed from the blocks in the preceding frame. The flow 600 also moves from block 632 to block 634 after the residual block, the number of dropped blocks, and/or the motion vector of the current block are provided to the wagering game machine. If it is determined that there exist additional blocks to be analyzed, the flow continues at block 608 in FIG. 6 where the next block of the current frame is identified and the loop executes for the next block. Otherwise, the flow ends.

FIGS. 8 and 9 depict a flow diagram illustrating example operations for video frame decoding in wagering game machines. Flow 800 begins at block 802 in FIG. 8.

At block 802, information associated with a current block of a current frame to be presented on a wagering game machine display unit is received. The flow continues at block 804.

At block 804, a number of dropped blocks is determined from the received information. For example, a received signal can be demodulated and the information can be extracted, decrypted, decoded, etc. to retrieve the number of dropped blocks. As described above, the number of dropped blocks indicates the number of blocks prior to the current block that were dropped. The flow continues at block 806.

At block 806, it is determined whether the number of dropped blocks is equal to zero. The number of dropped blocks indicates a number of blocks that can be reconstructed based on blocks in a preceding frame and based on the motion vector of a preceding block of a current frame. If the number of dropped blocks is greater than zero, the motion vector of the preceding block can be used to reconstruct the dropped blocks. If it is determined that the number of dropped blocks is equal to zero, the flow continues at block 814 in FIG. 9. Otherwise, the flow continues at block 808 where blocks to be inserted to precede the current block of the current frame are identified.

At block 808, a reconstruction source block is identified in the preceding frame based on the motion vector of the preceding block of the current frame. The motion vector of the preceding block of the current frame can be determined and used to identify the reconstruction source block. The reconstruction source block is identified as the block of the preceding frame taking into account the motion vector of the preceding block of the current frame. The flow continues at block 809.

At block 809, a dropped block is reconstructed based on the identified reconstruction source block. Reconstruction can involve cloning video data of the reconstruction source block for the reconstructed dropped block. In another implementation, a new block can be created and populated and/or modified with data from the reconstruction source block. In another implementation, the reconstruction source block can be copied, and the copy modified for the current frame.

At block 810, the reconstructed dropped block is inserted to precede the current block. The information received at block 802 may comprise an indication of the position of the dropped blocks in the current frame. The position of the reconstructed dropped blocks in the current frame may be described with reference to the current block. For example, based on knowledge that the current block is the 20^{th} block of the current frame and that 1 block prior to the current block was dropped, the reconstructed dropped block may be inserted as the 19^{th} block of the current frame. The position of the reconstructed dropped block(s) may also be determined based on knowledge of an order in which the blocks were processed during a block compression stage. For example, based on knowledge that the blocks were processed in raster order during the block compression stage, the reconstructed dropped block may be ordered so that the raster order is maintained. The flow continues at block 812.

At block 812, the number of dropped blocks is decremented. The flow loops back to block 806, where it is determined whether the number of dropped blocks is zero. If so, the flow continues at block 814 in FIG. 9. Otherwise, the operations described with reference to blocks 808-812 are performed for each dropped block until there are no additional dropped blocks.

At block 814 in FIG. 9, it is determined whether a motion vector associated with the current block was received. The absence of the motion vector associated with the current block can indicate that the current block cannot be reconstructed based on blocks in the preceding frame. In other words, the absence of a motion vector associated with the current block can indicate that no blocks in the preceding frame match (within a predetermined threshold) the current block. If it is determined that the motion vector associated with the current block was received, the flow continues at block 818. Otherwise, the flow continues at block 816.

At block 816, a predictive block is generated for the current block. The predictive block can be generated based on a subset of previously decoded blocks in the current frame. In one implementation, thirteen blocks along an upper boundary and a left boundary of the current block may be used to generate the predictive block. In another implementation, any suitable number of blocks can be used to generate the predictive block. The number of blocks and the position of the blocks to be used to generate the predictive block may be received as part of the information (at block 802) or may be determined based on knowledge of a block prediction scheme implemented during the block compression stage. The flow continues at block 822.

At block 818, a matched block is identified from the preceding frame based on the motion vector associated with the current block. The flow 800 moves from block 814 to block 818 on determining that the motion vector associated with the current block was received. The flow continues at block 820.

At block 820, it is determined whether the residual block associated with the current block was received. Absence of the residual block can indicate that the current block can be completely reconstructed from the matched block identified at block 818. If it is determined that the residual block associated with the current block was received, the flow continues at block 822. Otherwise, the flow continues at block 824.

At block 824, the matched block is inserted as the current block into a decoded block stream that represents the current frame. The absence of the residual block associated with the current block indicates that the matched block exactly matches the current block. From block 824, the flow ends.

At block 822, the current block is reconstructed based, in part, on the residual block. The flow 800 moves from block 820 to block 822 on determining that the residual block associated with the current block was received. The flow 800 also moves from block 816 to block 822 after the predictive block is generated for the current block. The residual block can be combined with the matched block or with the predictive block (as applicable) to reconstruct the current block. The residual block and the matched block/predictive block may be added, combined as a weighted sum, etc. to reconstruct the current block. From block 822, the flow ends.

It should be noted that although FIGS. 8-9 depict the flow ending after the current block is reconstructed, embodiments are not so limited. After the current block is reconstructed, information associated with a next block (or a next set of blocks) may be received and processed to reconstruct the next block(s) that constitute the current frame. After the blocks that constitute the current frame are reconstructed, the blocks can be assembled to generate the current frame for presentation on a display unit of the wagering game machine. The information received at block 802 in FIG. 8 can comprise an indication of how the blocks should be arranged to generate the current frame for presentation on the display unit. The indication can comprise a number of blocks in the current frame, a number of order strips that constitute the current frame, a block identifiers, etc. In some implementations, the blocks can be ordered as they are reconstructed.

Moreover, although examples refer to blocks, embodiments are not limited to blocks as defined by conventional compression techniques (e.g., macroblocks). The video compression technique can be applied to a region or area of a frame that may not conform to the standard definition of a block. Embodiments can operate upon an area of a frame that can comprise multiple atomic video frame units (i.e. a smallest unit of a video frame that is processed for compression/decompression), which may or may not be blocks. Embodiments are also not limited to processing a rectangular or square area of a frame. Embodiments can determine an area of a frame (e.g., an area of a reel-spin video that encompasses multiple reels, an entire column and a portion of an adjacent column, etc.) that moves at a same rate, or substantially same rate. Instead of encoding a number of dropped blocks, embodiments can encode values that represent boundaries of the area. Thus, the encoding side will encode and transmit area boundary values and a motion vector in some embodiments. In some embodiments, the decoding side will reconstruct the area with a matching or substantially matching area of a preceding frame based on the motion vector and the boundary values. The boundary values can range from a single value to several values. For instance, the decoding side can determine an area with a single boundary value by using the boundary value as a center point and using a predetermined value to expand from the center point. As another example, the decoding side can determine the area with two boundary values. The boundary values can indicate two corners of a rectangular or square area, and the decoding side can determine the area accordingly. In some cases, the area being compressed and/or decompressed may not even be contiguous. In some videos with predictable motion, a bottom portion will be depicted as moving off a display to reappear at another portion of the display (e.g., rotating from bottom to top of a display). For instance, a frame compression unit can encode boundary values for multiple non-contiguous areas to be reconstructed based on a same motion vector. The frame compression unit can encode a value that indicates to the frame content restoration unit that an area will jump to a different portion of a display. For example, the frame content restoration unit will recognize that a matching area of a preceding frame will be at a bottom of the preceding frame for an area to be reconstructed at a top of a current frame. Embodiments can also encode a motion vector without such a hint, and configure the frame content restoration unit to recognize when an area moves off the display, and when an area jumps to a different portion of the display (e.g., a resulting position that is off display but within a certain threshold indicates that the area will move to a top of the display).

In addition, embodiments can implement an acceleration/deceleration guided search for matching areas, and extend the compression to cover more frames. For example, a frame compression unit can begin searching for a matching area based on decrementing and/or incrementing the motion vector. The decrementing/incrementing can be at different levels of granularity (e.g., single pixels, a threshold delta amount, etc.). Embodiments can also increment or decrement based on a difference in motion vectors of preceding frames. A video can accelerate/decelerate to a velocity that is maintained for some time or number of frames, and then accelerate/decelerate again. The search can give preference to accelerating or decelerating guided search based on video characteristics. If a video typically accelerates at first, then a frame compression unit can initially perform an acceleration guided search when searching for a matching area. At the first sign of deceleration, the frame compression unit can set a flag that represents the video transitioning to deceleration. Embodiments can treat acceleration and deceleration as equally possible, and perform a back and forth search. For example, a frame compression unit can search based on a motion vector decremented by x; then search based on an motion vector incremented by x; then search based on a motion vector decremented by x+y; then search based on a motion vector incremented by x+y; and so on. Furthermore, embodiments can search based on knowledge of particular movements, such as a short up movement that precedes a down movement in some reel-spin videos.

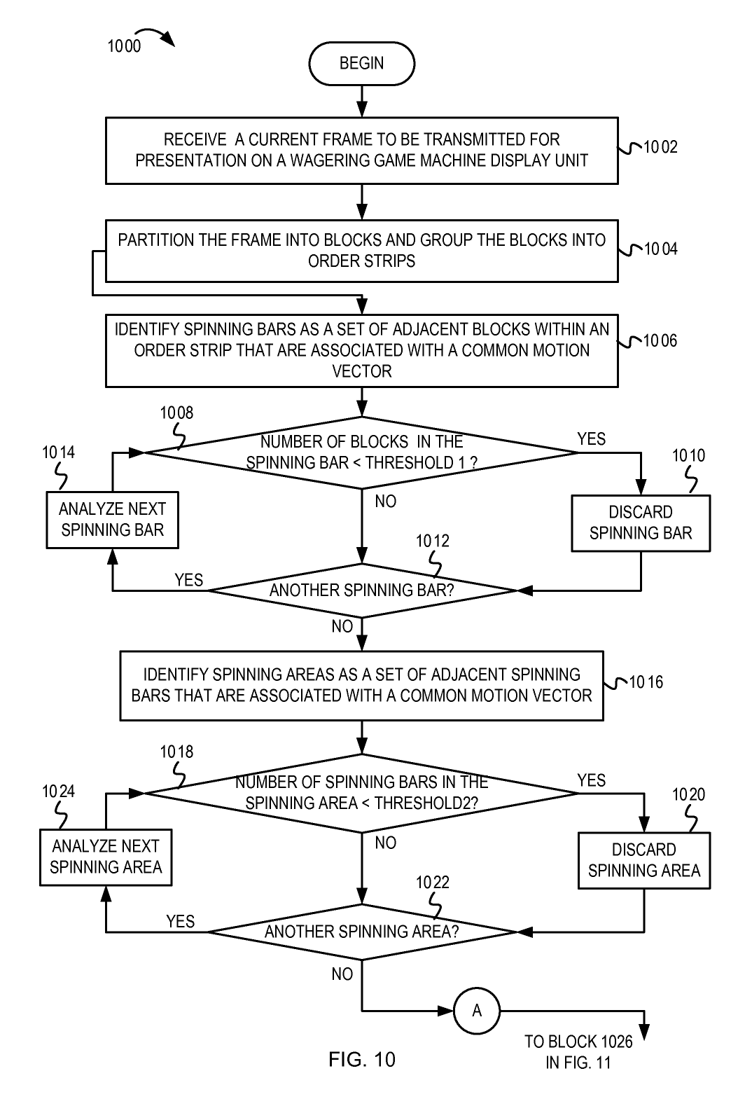

Although FIGS. 1-9 describe compression and transmission of all content presented by a reel-spinning video frame, embodiments are not so limited. Embodiments can selectively encode/compress and transmit different portions of presented content in accordance with different techniques. For instance, a content server can encode/compress a reel-spin area of a video frame to a wagering game machine in accordance with the reel-spinning compression technique while encoding/compressing a different portion of the video frame in accordance with a different technique. In addition, a display of a wagering game machine can display content from different content servers (e.g., reel-spin, animation, portal games, bonus games, etc.), as well as from the wagering game machine itself (e.g., background, sprites, etc.). A reel-spin area can be extracted from a current reel-spinning video frame and encoded separately from the remainder of the current reel-spinning video frame. FIGS. 10, 11, and 12 describe operations for separately encoding and decoding the reel-spin area and the other content of the current reel-spinning video frame.

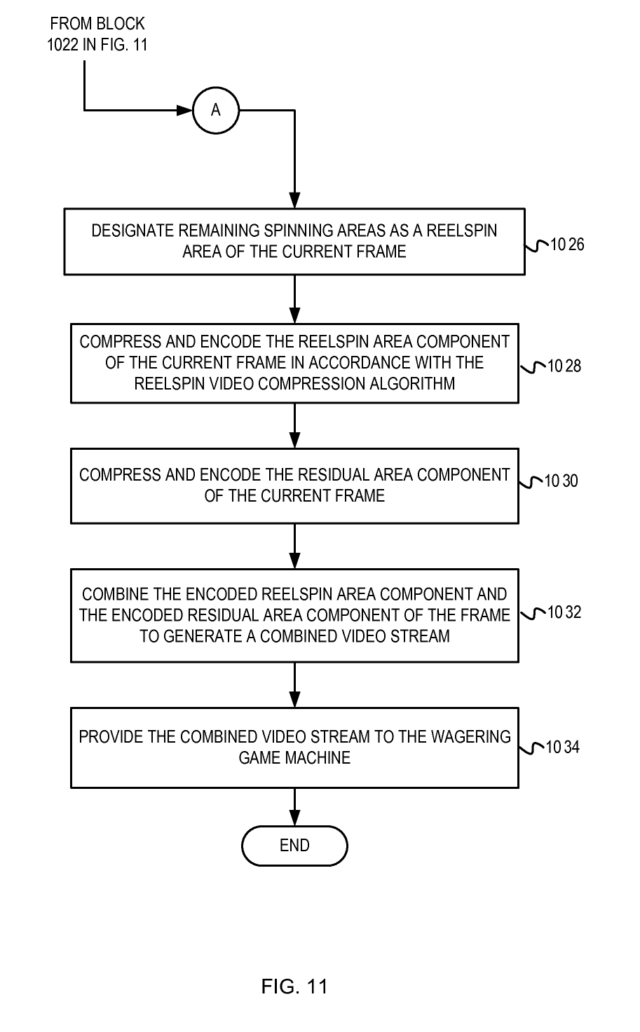

FIGS. 10 and 11 depict a flow diagram illustrating example operations for separately encoding a reel-spin area and a residual area of a reel-spinning video frame. Flow 1000 begins at block 1002 in FIG. 10.

At block 1002, a current frame to be transmitted for presentation on a wagering game machine display unit is received. The current frame can comprise a reel-spin area and other content (e.g., images, text, animation, portal games, bonus games, social networking content, streaming video, etc.) around the reel-spin area. The reel-spin area comprises multiple reels, each comprising a set of images that appear to move in a vertical downward direction responsive to user input. After the current frame is received, the reel-spin area is extracted from the current frame to yield a reel-spin area component of the current frame and a residual area component of the current frame. Operations for extracting the reel-spin area component of the current frame are further described in blocks 1004-1026. The flow continues at block 1004.

At block 1004, the current frame is partitioned into blocks and the blocks are grouped into order strips. The current frame may be partitioned into any suitable number of blocks depending on the requisite compression ratio, content of the current frame, a size of the current frame, a maximum block size, etc. Also, the blocks are grouped into order strips so that a block width equals an order strip width. In other words, each block column may be designated as a separate order strip. The flow continues at block 1006.

At block 1006, spinning bars are identified as an adjacent set of blocks within an order strip that are associated with a common motion vector. The horizontal component of the blocks that constitute the spinning bars is zero because blocks in the reel-spin area do not have a horizontal displacement. Because each order strip constitutes a single block column, the blocks in the block column are traversed vertically to identify the adjacent set of blocks that are associated with a common motion vector. The flow continues at block 1008.

At block 1008, it is determined whether the number of blocks in the spinning bar is less than a first threshold. The first threshold can represent the minimum number of blocks that can constitute the reel-spin area. The first threshold can be determined based on knowledge of the block size, a reel-spin area, etc. For example, it may be determined that the reel-spin area spans a minimum of 20 blocks while traversing vertically through the current frame. If it is determined that the number of blocks in the spinning bar is less than the first threshold, the flow continues at block 1010. Otherwise, the flow continues at block 1012.

At block 1010, the spinning bar is discarded. The flow 1000 moves from block 1008 to block 1010 if it is determined that the number of blocks in the spinning bar is less than the first threshold. In other words, the spinning bar is not considered as part of the reel-spin area if the number of blocks that constitute the spinning bar is less than the first threshold. The flow continues at block 1012.

At block 1012, it is determined whether there exists another spinning bar to be analyzed. The flow 1000 also moves from block 1008 to block 1012 if it is determined that the number of blocks that constitute the spinning bar is greater than or equal to the first threshold. The flow 1000 moves to block 1012 after a current spinning bar is analyzed and is either discarded or retained. If it is determined that there exists another spinning bar to be analyzed, the flow continues at block 1014. Otherwise, the flow continues at block 1016.

At block 1014, a next spinning bar is retrieved and analyzed. The flow continues at block 1008 where it is determined whether the number of blocks that constitute the next spinning bar is less than the first threshold.

At block 1016, spinning areas are identified as a set of adjacent spinning bars that are associated with a common motion vector. The horizontal component of the blocks that constitute the spinning areas is zero because blocks in the reel-spin area do not have a horizontal displacement. The flow continues at block 1018.

At block 1018, it is determined whether the number of spinning bars that constitute a spinning area is less than a second threshold. The second threshold can represent the minimum number of adjacent spinning bars that can constitute the reel-spin area. The second threshold can be determined based on knowledge of the block size, a width of a reel in the reel-spin area, a reel-spin area, etc. If it is determined that the number of spinning bars that constitute the spinning area is less than the second threshold, the flow continues at block 1020. Otherwise, the flow continues at block 1022.

At block 1020, the spinning area is discarded. The flow 1000 moves from block 1018 to block 1020 if it is determined that the number of spinning bars that constitute the spinning area is less than the second threshold. In other words, the spinning area (i.e., the group of spinning bars) is not considered to be part of the reel-spin area if the number of spinning bars that constitute the spinning area is less that the second threshold. The flow continues at block 1022.

At block 1022, it is determined whether there exists another spinning area to be analyzed. The flow 1000 also moves from block 1018 to block 1022 if it is determined that the number of spinning bars that constitute the spinning area is greater than or equal to the second threshold. If it is determined that there exists another spinning area to be analyzed, the flow continues at block 1024. Otherwise, the flow continues at block 1026 in FIG. 11.

At block 1024, a next spinning area is identified and analyzed. The flow continues at block 1018 where it is determined whether the number of spinning bars that constitute the next spinning area is less than the second threshold. After all the spinning areas have been analyzed, the flow continues at block 1026 in FIG. 11.

At block 1026 in FIG. 11, the remaining spinning areas on the current frame are designated as the reel-spin area component of the current frame. The reel-spin area component of the current frame is subtracted from the current frame to yield a residual component of the current frame. The flow continues at block 1018.

At block 1028, the reel-spin area component of the current frame is compressed and encoded using a reel-spinning video compression algorithm. The reel-spinning video compression algorithm was described with reference to FIGS. 6 and 7. A motion vector for the reel-spin area component and position of the reel-spin area component within the current frame is encoded. Other information (e.g., a residual block, a number of dropped blocks, etc.) associated with each block that constitutes the reel-spin area component may also be transmitted (if required) as described with reference to FIGS. 6-7. The flow continues at block 1030.

At block 1030, the residual area component of the current frame is compressed and encoded. The residual area component of the current frame could be compressed and encoded using any suitable video encoding and compression techniques (e.g., video compression in accordance with the H.264 standard). In some implementations, the residual area component may also be encoded using the reel-spinning video compression algorithm described in FIGS. 6-7. Moreover, positions in the residual area component that correspond to the reel-spin area component may be removed or may be substituted with a predefined value to indicate that the reel-spin area component will be encoded and provided separately. The flow continues at block 1032. As stated earlier, operations can occur in a different order. The operations indicated in blocks 1028 and 1030 can be performed in parallel (e.g., by different hardware decoders, different threads, different cores, etc.), or the operations of block 1030 can be performed before the operations of block 1028,

At block 1032, the encoded reel-spin area component and the encoded residual area component of the current frame are combined to generate a combined video stream. The encoded reel-spin area component and the encoded residual area component of the frame may be multiplexed (e.g., using frequency division multiplexing, code division multiplexing, etc.) to generate the combined video stream. In some implementations, however, the residual area component and the reel-spin area component may be transmitted as separate video streams. For example, the residual area component may be transformed (e.g., quantized, encrypted, modulated, etc.) into a format suitable for transmission and a first signal comprising the residual area component may be transmitted. Also, the reel-spin area component can be similarly transformed into a format suitable for transmission and a second signal comprising the reel-spin area component may be transmitted. The flow continues at block 1034.

At block 1034, the combined video stream is provided to the wagering game machine. A decoding unit on the wagering game machine can reconstruct the current frame from the combined video stream and provide the current frame for display on the wagering game machine display unit. From block 1034, the flow ends.

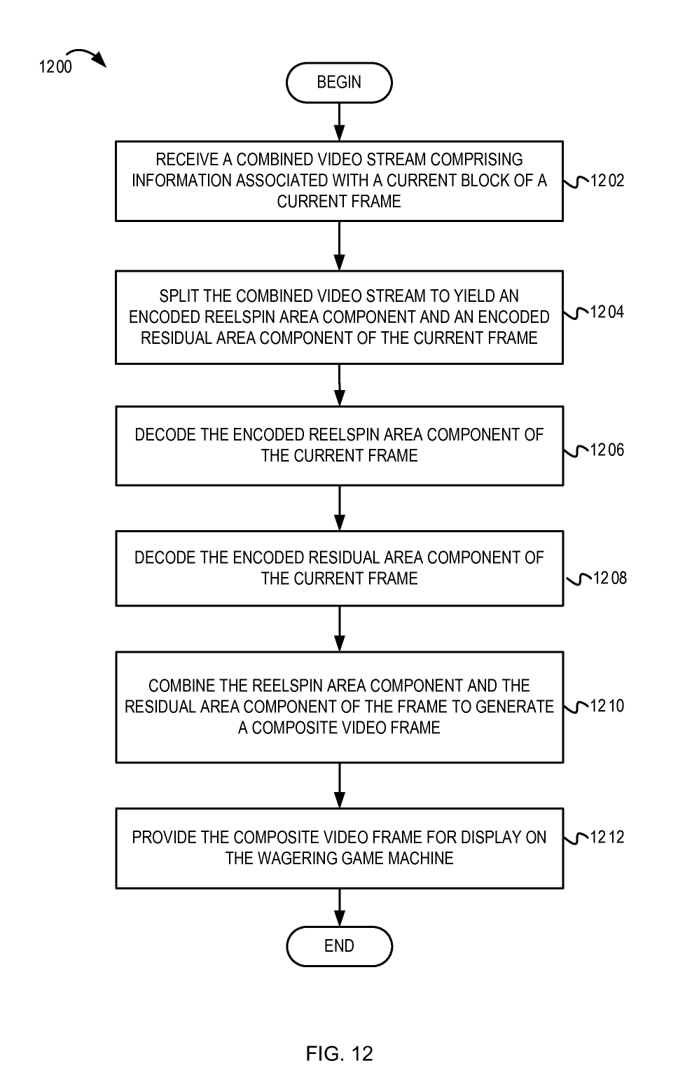

FIG. 12 is a flow diagram illustrating example operations for separately decoding a reel-spin area component and a residual area component of a reel-spinning video frame. Flow 1200 begins at block 1202.

At block 1202, a combined video stream comprising information associated with a current block of a current frame is received for display on a wagering game machine. The combined video stream is received as a result of separate encoding operations described in FIGS. 10-11. The flow continues at block 1204.

At block 1204, the combined video stream is split to yield an encoded reel-spin area component and an encoded residual area component of the current frame. The combined video stream may be demultiplexed to retrieve the encoded reel-spin area component and the encoded residual area component of the current frame. For example, a flag in a header of a received video stream can indicate whether the received video stream is a combined video stream. It is noted, however, that in some implementations the encoded reel-spin area component and the encoded residual area component may be received in two separate video streams. The flow continues at block 1206.

At block 1206, the encoded reel-spin area component of the current frame is decoded. Decoding operations described with reference to FIG. 8 and FIG. 9 can be executed to decode the reel-spin area component of the current frame. The flow continues at block 1208.

At block 1208, the encoded residual area component of the current frame is decoded. Based on encoding operations performed on the residual area component of the frame, corresponding decoding operations can be performed to retrieve the residual area component of the current frame. For example, if H.264 encoding was applied to encode the residual area component, H.264 decoding is applied to decode the encoded residual area component. The flow continues at block 1210.

At block 1210, the reel-spin area component and the residual area component of the current frame are combined to generate a composite video frame. Compositing techniques can be used to combine the reel-spin area component and the residual area component to re-create the current frame for presentation on a display unit of the wagering game machine. The flow continues at block 1212.

At block 1212, the composite video frame is provided for display by the wagering game machine. From block 1212, the flow ends.

It should be noted that although FIGS. 1-12 describe dropping the current block of the current frame if the current block can be reconstructed based on the motion vector of the preceding block of the current frame and based on blocks in the preceding frame, embodiments are not so limited. In some implementations, the entire current frame may be dropped if the current frame comprises the same content as the preceding frame. A timestamp indicating when the current frame should be reconstructed may be transmitted in place of the current frame. For example, once a reel-spinning video starts, frames between a first frame of the reel-spinning video and an N^{th} frame of the reel-spinning video when the reel spin speed decreases may be the same and may therefore be dropped. Therefore, the first frame may be transmitted along with timestamps that indicate when the dropped N−2 frames should be reconstructed and presented on the display unit. During a decoding stage, the first frame can be used to reconstruct the dropped frames.

It is also noted that although FIGS. 10-11 describe operations for determining the position of the reel-spin area on the current frame (described in blocks 1004-1026), prior to extracting the reel-spin area from the current frame, embodiments are not so limited. The operations described in blocks 1004-1026 may be executed if a description of the reel-spin area (e.g., a position or area of the reel-spin area on the current frame) is not available. In some implementations, the position of the reel-spin area may be determined based on available coordinates identifying the position of the reel-spin area on the current frame. In other implementations, screen capture software may be used to obtain screenshots of a video slots wagering game being presented on the wagering game machine. The screenshots may be analyzed to determine the position of the reel-spin area on the frame. It is noted that after the position of the reel-spin area is determined, the position of the reel-spin area may be stored and used as a reference for future frames.

Lastly, it is noted that the block size (e.g., height and width of the block, number of pixels in each block, etc.) can impact the compression ratio. Although a smaller block size can improve the compression ratio, the smaller block size also increases computation complexity. In one implementation, the block size may be 16×16 pixels or 16×8 pixels to maximize the use of an H.264 compression algorithm when not streaming reel-spinning videos. Alternately, the blocks can be any suitable size and can be determined based on experiments to optimize block size. Additionally, the order strip size could be increased or decreased as desired to vary the compression ratio and to vary performance accordingly. In some implementations, the width of the order strip may be equal to the width of the frame and may comprise all blocks that constitute the frame. As an example, to achieve a high compression ratio, the frame may be designed so that the reel-spin area covers the entire frame and the order strip width equals the block width. Thus, only the motion vector of the first block may be transmitted and all subsequent blocks in the frame may be dropped. However, when the reel-spin area does not cover the entire frame, the block size and the order strip width can be selected to drop as many blocks as possible when streaming reel-spinning videos and to strike a balance between computational complexity and compression ratio.

In some implementations, a frame compression unit can be configured to dynamically vary the block size and the order strip width based on the content of the current frame. A first combination of block size and order strip size may be used when a reel-spinning video is to be transmitted. A second combination of block size and order strip size may be transmitted when other content (not reel-spinning videos) are to be transmitted. During transmission, a flag can be set to indicate (to the decoder) whether the first or the second combination of block size and order strip size should be used for decoding.

### Operating Environment

This section describes an example operating environment and presents structural aspects of some embodiments. This section includes discussion about wagering game networks and wagering game machine architectures.

### Wagering Game Networks

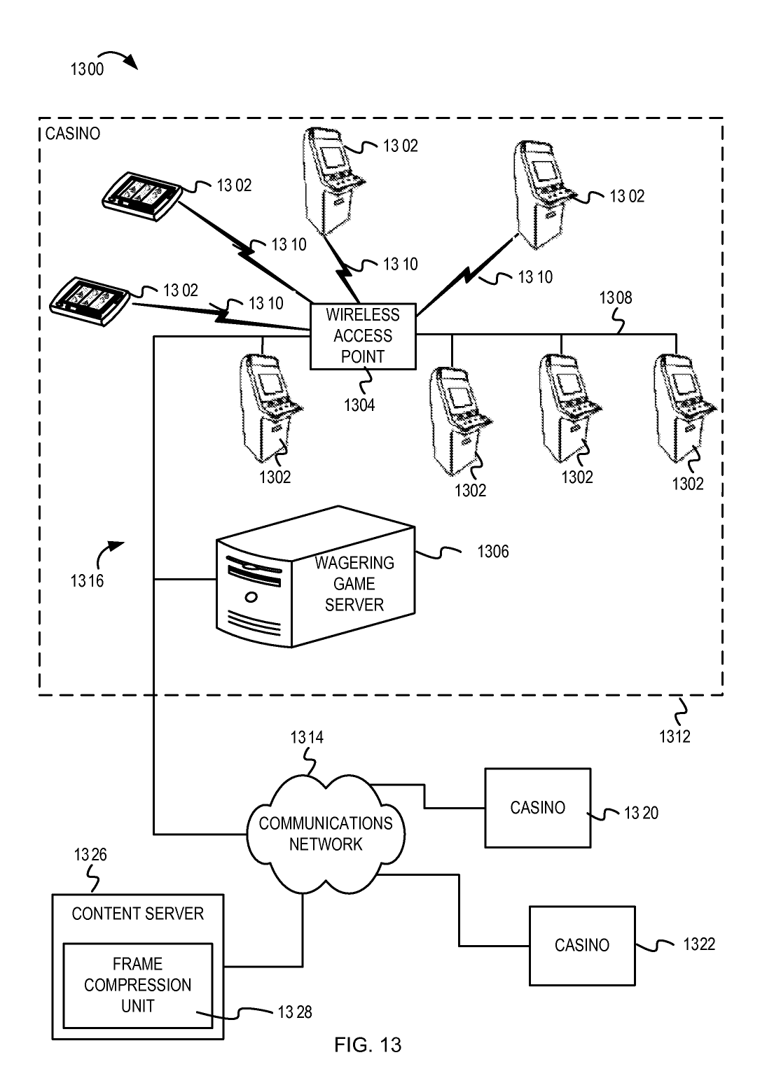

FIG. 13 is a block diagram illustrating a wagering game network 1300, according to example embodiments of the invention. As shown in FIG. 13, the wagering game network 1300 includes a plurality of casinos 1312 connected to a communications network 1314. The plurality of casinos 1312, 1320, and 1322 is also connected to a content server 1326. The content server 1326 comprises a frame compression unit 1328.

Each casino 1312 includes a local area network 1316, which includes an access point 1304, a wagering game server 1306, and wagering game machines 1302. The access point 1304 provides wireless communication links 1310 and wired communication links 1308. The wired and wireless communication links can employ any suitable connection technology, such as Bluetooth, 802.11, Ethernet, public switched telephone networks, SONET, etc. In some embodiments, the wagering game server 1306 can serve wagering games and distribute content to devices located in other casinos 1312 or at other locations on the communications network 1314. Although both the wagering game server 1306 and the content server 1326 are depicted in FIG. 13, both entities are not necessary in a network. The wagering game server can comprise a frame compression unit 1328 instead of the content server 1326. In that case, the casino can forego the content server 1326, the content server can provide reel-spinning video for games different than the wagering game server 1306, or the content server can server other content. In other embodiments, the content server 1326 can perform the operations of the wagering game server 1306, and the casino can utilize the wagering game server 1306 for other wagering games that do not involve reel-spinning. In another embodiment, the content server 1326 and the wagering game server 1306 can provide content, perhaps cooperatively, to one or more wagering game machines to be presented together (or in an alternating fashion).

The frame compression unit 1328 implements functionality for compressing reel-spinning video frames for presentation on a wagering game machine 1302 based, at least in part, on the content of the reel-spinning video frames generated by the content server 1326. The frame compression unit 1328 divides a current frame into multiple blocks depending on a required compression ratio. The frame compression unit 1328 determines a motion vector associated with the current block. The frame compression unit 1328 may assign a motion vector of a preceding block to the current block, if the preceding block has a valid motion vector. The frame compression unit 1328 can compare the current block with a subset of blocks in a preceding frame. The frame compression unit 1328 can determine whether a block that exactly matches the current block and is associated with the same motion vector as that of the current block can be identified. If so, the frame compression unit 1328 can drop the current block and can begin analysis of a next block. If the frame compression unit 1328 determines that the motion vector associated with the preceding block is not valid and if the frame compression unit 1328 identifies a matched block of the preceding frame that matches the current block, the frame compression unit 1328 can assign the motion vector of the matched block to the current block. If no match for the current block can be found in the preceding frame, the frame compression unit 1328 can generate a predictive block based on previously encoded blocks in the current frame. The frame compression unit 1328 can generate a residual block to indicate differences between the current block and the predictive block/matched block. The frame compression unit 1328 can provide (after quantization, entropy encoding, etc.) the motion vector associated with the current block, a number of blocks prior to the current block that were dropped, and/or the residual block to the wagering game machine 1302. A decoder in the wagering game machine 1302 can decode and reconstruct the current frame as described with reference to FIGS. 8 and 9.

The wagering game machines 1302 described herein can take any suitable form, such as floor standing models, handheld mobile units, bartop models, workstation-type console models, etc. Further, the wagering game machines 1302 can be primarily dedicated for use in conducting wagering games, or can include non-dedicated devices, such as mobile phones, personal digital assistants, personal computers, etc. In one embodiment, the wagering game network 1300 can include other network devices, such as accounting servers, wide area progressive servers, player tracking servers, and/or other devices suitable for use in connection with embodiments of the invention.

In some embodiments, wagering game machines 1302 and wagering game servers 1306 work together such that a wagering game machine 1302 can be operated as a thin, thick, or intermediate client. For example, one or more elements of game play may be controlled by the wagering game machine 1302 (client) or the wagering game server 1306 (server). Game play elements can include executable game code, lookup tables, configuration files, game outcome, audio or visual representations of the game, game assets, or the like. In a thin-client example, the wagering game server 1306 can perform functions such as determining game outcome or managing assets, while the wagering game machine 1302 can present a graphical representation of such outcome or asset modification to the user (e.g., player). In a thick-client example, the wagering game machines 1302 can determine game outcomes and communicate the outcomes to the wagering game server 1306 for recording or managing a player's account.

In some embodiments, either the wagering game machines 1302 (client) or the wagering game server 1306 can provide functionality that is not directly related to game play. For example, account transactions and account rules may be managed centrally (e.g., by the wagering game server 1306) or locally (e.g., by the wagering game machine 1302). Other functionality not directly related to game play may include power management, presentation of advertising, software or firmware updates, system quality or security checks, etc.

Any of the wagering game network components (e.g., the wagering game machines 1302) can include hardware and machine-readable media including instructions for performing the operations described herein.

### Wagering Game Machine Architectures

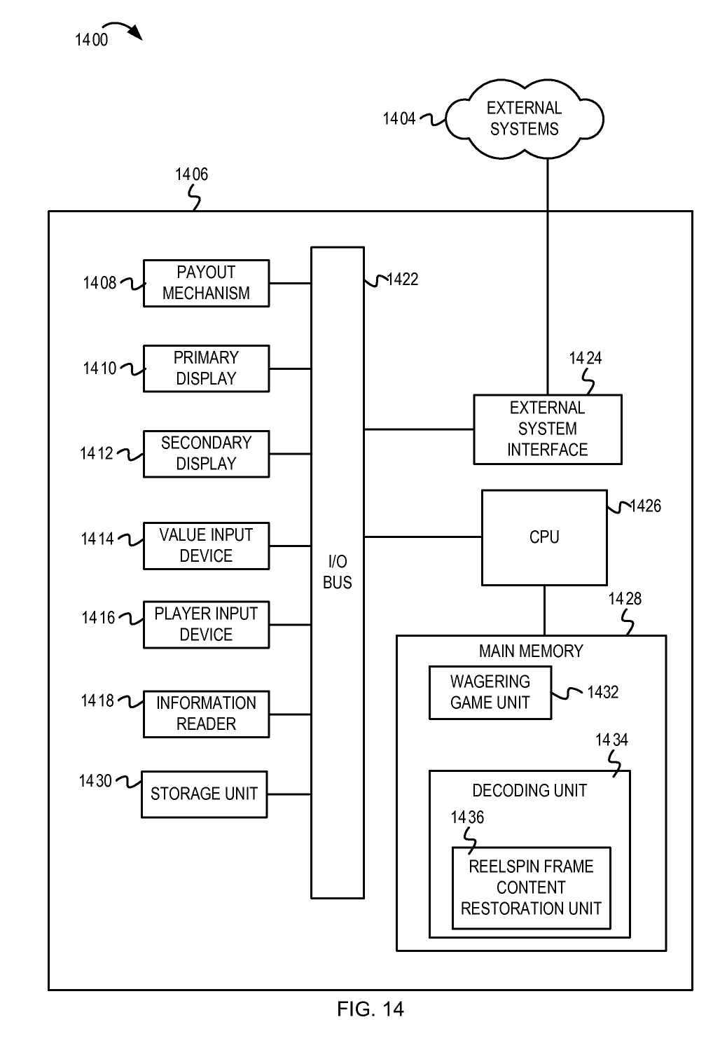

FIG. 14 is a block diagram illustrating wagering game machine architecture, according to example embodiments of the invention. As shown in FIG. 14, the wagering game machine architecture 1400 includes a wagering game machine 1406, which includes a central processing unit (CPU) 1426 connected to main memory 1428. The CPU 1426 can include any suitable processor, such as an Intel® Pentium processor, Intel® Core 2 Duo processor, AMD Opteron™ processor, or UltraSPARC processor. The main memory 1428 includes a wagering game unit 1432 and a decoding unit 1434. The decoding unit 1434 comprises a reel spin frame content restoration unit 1436. In one embodiment, the wagering game unit 1432 can present wagering games, such as video slots. Embodiments are not limited to implementing the decoding unit 1434 and/or the reel spin frame content restoration unit 1436 in machine-readable media (e.g., the main memory 1428). Embodiments can implement the decoding unit 1434 and/or the reel spin frame content restoration unit 1436 as an application specific integrated circuit or a field programmable gate array.

The frame content restoration unit 1436 implements functionality for reconstructing blocks that constitute video frames as described with reference to FIGS. 5, 8, and 9. The CPU 1426 is connected to an input/output (I/O) bus 1422, which can include any suitable bus technologies, such as an AGTL+ frontside bus and a PCI backside bus. The I/O bus 1422 is connected to a payout mechanism 1408, primary display 1410, secondary display 1412, value input device 1414, player input device 1416, information reader 1418, and storage unit 1430. The player input device 1416 can include the value input device 1414 to the extent the player input device 1416 is used to place wagers. The I/O bus 1422 is also connected to an external system interface 1424, which is connected to external systems 1404 (e.g., wagering game networks).

In one embodiment, the wagering game machine 1406 can include additional peripheral devices and/or more than one of each component shown in FIG. 14. For example, in one embodiment, the wagering game machine 1406 can include multiple external system interfaces 1424 and/or multiple CPUs 1426. In one embodiment, any of the components can be integrated or subdivided.

Any component of the architecture 1400 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). Machine-readable media can be machine-readable storage media or machine-readable signal media. Examples of machine-readable storage media include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Examples of machine-readable signal media can be in the form of an electro-magnetic signal, an optical signal, or any suitable combination thereof.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. For instance, although the examples refer to reel-spinning video, embodiments are not so limited. The video compression described herein can be applied to other video that comprises a region or area that moves in a predictable manner at a predictable velocity and/or acceleration within a given threshold across multiple frames. Although the examples refer to unidirectional movement as an instance of predictable movement, predictable motion can also involve a repeating pattern of movement in multiple directions. Similarly, instances of predictable velocity and/or acceleration can involve repeating patterns in speed and/or acceleration. In some embodiments, the predictable aspects are known in advance. For example, an encoded can be configured to recognize a particular pattern, game, content, etc., and then access data that informs the encoder about the acceleration over a number of frames, etc. As another example, an encoder can be configured to recognize a predictable pattern over a number of frames, and then apply the compression technique described herein to subsequent sets of frames with the assumption that the predictable pattern repeats every x frames. Embodiments can also compress videos that have multiple different patterns that repeat throughout a video. Embodiments can use hints to compress according to each occurring pattern or adapt as patterns are recognized. The video compression described herein can be applied to a limited portion of a video. Furthermore, embodiments are not limited to a direction along a single axis. Embodiments can be applied to video comprising a region or area moving in a single direction along multiple axis. Even though some embodiments utilize a coordinate to represent a number of dropped blocks, embodiments can use multiple coordinates to indicate a single direction, and indicate a number of dropped blocks as a separate parameter or variable. Each of the embodiments described herein are contemplated as falling within the inventive subject matter, which is set forth in the following claims.

1. A method for decompressing a wagering game reel spin video comprising:
determining that an area of the wagering game reel spin video has a predictable movement over a plurality of frames of the wagering game reel-spin video, wherein the plurality of frames comprise a current frame and a preceding frame;
selecting the area within the preceding frame of the plurality of frames based on a motion vector that represents the predictable movement of the area from the preceding frame to the current frame, wherein the current frame is being reconstructed; and
reconstructing the area within the current frame with image data of the area within the preceding frame and the motion vector and without having received image data of the area within the current frame.

2. The method of claim 1, wherein said determining that the area of the wagering game reel spin video has the predictable movement over the plurality of frames of the wagering game reel-spin video comprises:
determining that the motion vector is a valid motion vector for a plurality of blocks that constitute the area of the current frame.

3. The method of claim 2 wherein said determining that the motion vector is a valid motion vector comprises one of:
determining that received compressed data that represents the area within the current frame does not indicate the motion vector and using the motion vector of a preceding area within the current frame;
determining that the received compressed data that represents the area within the current frames references the preceding area within the current frame; and
determining that the valid motion vector lies within a valid range of values for the wagering game reel spin video.

4. The method of claim 1, wherein the predictable movement comprises a predictable direction and a predictable acceleration.

5. The method of claim 1 wherein said determining that the area of the wagering game reel spin video has the predictable movement over the plurality of frames of the wagering game reel-spin video comprises:
decoding boundary value data from received compressed data that represents the area within the current frame, wherein the boundary value data indicates boundaries of the area,
wherein said selecting the area within the preceding frame of the plurality of frames is also based on the boundary value data.

6. The method of claim 1, wherein said reconstructing the area within the current frame with the image data of the area within the preceding frame and the motion vector and without having received image data of the area within the current frame comprises determining one of a size of the area within the current frame without compressed image data for the area within the current frame and determining a number of dropped blocks that constitute the area within the current frame.

7. The method of claim 1 further comprising:
changing a size of atomic video frame units that constitute a subsequent frame of the wagering game reel spin video to be different than a size of atomic video frame units that constitute the area within the current frame, wherein the plurality of frames also comprise the subsequent frame.

8. The method of claim 1 further comprising changing a size of order strips of a subsequent frame to be different than a size of order strips of the current frame, wherein a first of the order strips of the subsequent frame comprises a number of columns of blocks that constitute the area, wherein the number of columns of blocks corresponds to the size of the order strips of the subsequent frame, wherein the plurality of frames also comprise the subsequent frame.

9. One or more machine-readable storage media encoded with instructions executable by a machine, the instructions configured to:
determine that a first contiguous set of atomic video frame units in a current frame of a reel spin video between a first and second atomic video frame units in the current frame move in a same single direction and at a same rate as the first atomic video frame unit of the current frame and that the first contiguous set of atomic video frame units corresponds to a second contiguous set of atomic video frame units in a preceding frame of the reel spin video;
record an indication of the first contiguous set of atomic video frame units for which image data will not be encoded and transmitted; and
encode the current frame with an indication of the number of the first contiguous set of atomic video frame units and without image data for the first contiguous set of atomic video frame units.

10. The machine-readable storage media of claim 9, wherein the instructions configured to encode the current frame with the indication of the indication of the first contiguous set of atomic video frame units comprises the instructions being configured to encode the indication of the first contiguous set of atomic video frame units with either the first atomic video frame unit or the second atomic video frame unit.

11. The machine-readable storage media of claim 9, wherein the instructions being configured to determine that the first contiguous set of atomic video frame units in the current frame of the reel spin video move in the same single direction and at the same rate as the first atomic video frame unit in the current frame comprises the instructions being configured to determine that a motion vector of the first atomic video frame unit is a valid motion vector for the first contiguous set of atomic video frame units.

12. The machine-readable storage media of claim 11, wherein the valid motion vector references a second atomic video frame unit within the current frame, lies within a valid range of values, or represents a valid motion for the reel spin video.

13. One or more machine-readable storage media encoded with instructions executable by a machine, the instructions configured to:
determine that a motion vector of a first block of a first video frame of a reel-spin video is valid for a first set of blocks of the first video frame that represent an area of the first video frame, wherein the first block precedes the first set of blocks;
determine that a second set of blocks of a second video frame corresponds to the first set of blocks of the first video frame, wherein the second video frame precedes the first video frame;
drop the first set of blocks of the first video frame based on a determination that the second set of blocks of the second video frame corresponds to the first set of blocks of the first video frame; and
record a number of dropped blocks as a number of the first set of blocks.

14. The machine-readable storage media of claim 13 further comprising second instructions configured to:
separate a first component of the current video frame, which corresponds to a reel-spin area on the first video frame, from a second component of the first video frame, which corresponds to a remainder area on the first video frame, wherein the reel-spin area comprises the first set of blocks of the first video frame and the remainder area on the first video frame corresponds to a difference between the first video frame and the reel-spin area;
encoding the first component in accordance with a first video compression technique that drops blocks;
encoding the second component in accordance with a second video compression technique different than the first video compression technique; and
transmitting the encoded first component and the encoded second component of the first video frame to a wagering game machine.

15. The machine readable storage media of claim 14, wherein the second instructions configured to transmit the encoded first component and the encoded second component of the first video frame to the wagering game machine comprises the second instructions being configured to:
transmit a combined stream comprising the encoded first component of the first video frame and the encoded second component of the first video frame, or
transmit the encoded first component of the first video frame and the encoded second component of the first video frame as separate streams.

16. The machine readable storage media of claim 13, wherein said second instructions being configured to separate the first component of the first video frame from the second component of the first video frame comprises the second instructions being configured to identify a contiguous group of blocks of the first video frame associated with a common motion vector, wherein the contiguous group of blocks corresponds to the reel-spin area.

17. The machine readable storage media of claim 16, wherein the second instructions are further configured to:
identify a plurality of spinning bars associated with the common motion vector, wherein each of the plurality of spinning bars comprises adjacent ones of the contiguous group of blocks;
determine that each of the plurality of spinning bars includes a number of adjacent ones of the group of blocks that exceeds a first threshold;
identify a plurality of spinning areas associated with the common motion vector, wherein each of the spinning areas comprises adjacent ones of the plurality of spinning bars; and
determine that each of the spinning areas includes a number of adjacent ones of the plurality of spinning bars that exceed a second threshold,
wherein the first component comprises the plurality of spinning areas.

18. An apparatus comprising:
a processor;
means for determining, using the processor, a series of blocks of a current frame of a reel spin video that can be discarded based on validity of a motion vector of a preceding block in the current frame for the series of blocks and based on determining a series of blocks of a preceding frame that correspond to the series of blocks of the current frame; and
means for transmitting an indication of a number of the series of blocks and transmitting the current frame without the set of blocks.

19. The apparatus of claim 18, further comprising means for determining that the series of blocks of the preceding frame correspond to the series of blocks of the current frame.

20. The apparatus of claim 18, further comprising means for determining validity of the motion vector of the preceding block for the series of blocks of the current frame.

21. The apparatus of claim 18, further comprising:
means for extracting a reel spin area component from the current frame, wherein the reel spin area component comprises the set of blocks; and
means for compressing the extracted reel spin area component in accordance with a first video compression algorithm and compressing a residual area component in accordance with a second video compression algorithm, wherein the residual area component comprises a difference between the current frame and the reel spin area component.

22. The apparatus of claim 18 further comprising means for encoding the number of the set of blocks that are discarded with a motion vector and residual block data for a subsequent block of the current frame.

23. A wagering game machine comprising:
a processing unit;
memory coupled with the processing unit; and
a video decoder coupled with the processing unit, the video decoder operable to,
determine that a current block of a current frame of a reel-spin video being decoded indicates a number of dropped blocks;
determine a motion vector associated with the dropped blocks;
determine a set of blocks of a preceding frame that correspond to the dropped blocks based, at least in part, on the motion vector;
reconstruct the dropped blocks based, at least in part, on the motion vector and the set of blocks of the preceding frame; and
insert the reconstructed dropped blocks into the current frame.

24. The wagering game machine of claim 23, wherein the motion vector is associated with a preceding block that precedes the current block, wherein the video decoder is operable to insert the reconstructed dropped blocks between the current block and the preceding block.

25. The wagering game machine of claim 23, further comprising the video decoder operable to:
separate a video stream into a first stream and a second stream;
decode the current frame from the first stream in accordance with a first decompression technique that restores dropped blocks;
decode a second frame from the second stream in accordance with a second decompression technique, wherein the second frame represents a residual area that corresponds to a difference between an original source video frame and the current frame; and
composite the decoded current frame and the decoded second frame.
